(19) United States
(12) Patent Application Publication
(10) Pub. No.: US 2008/0069732 A1
(43) Pub. Date: Mar. 20, 2008

(54) Diagnostic test system

(76) Inventors: Robert Yi, San Jose, CA (US); Scott Dylewski, San Jose, CA (US)

Correspondence Address: Kathy Manke;Avago Technologies Limited, 4380 Ziegler Road, Fort Collins, CO, 80525, US

(21) Appl. No.: 11/523,956

(22) Filed: Sep. 20, 2006

(51) Int. Cl. G01N 27/00

(52) U.S. Cl. 422/82.01

(57) ABSTRACT

A diagnostic test system includes a first layer and a base. The first layer is attached to the base to form one or more chambers. The diagnostic test system includes one or more pumps. Each one of the one or more pumps is configured to control a movement of a fluid within one of the one or more chambers by creating a deformation that changes a volume of the one of the one or more chambers.

### BACKGROUND

Many types of biological tests are performed in vitro to test for the presence or quantity of a substance associated with a particular disease or therapeutic state. To complete in vitro diagnostic testing on biological samples such as blood, urine or tissue, complex processing and handling procedures must be followed that include the creation of proper sample concentrations, removal of unwanted materials, use of proper reagent volumes and maintenance of proper environmental conditions such as temperature.

With conventional in vitro diagnostic testing methods, once a test has been prescribed, a sample must be collected, labeled, sorted and sent to an appropriate centralized testing laboratory that is usually at a remote location. At the laboratory, the sample is sorted and routed to an appropriate department (e.g. such as clinical chemistry, hematology, microbiology, or immunology) based on the particular assay required. Next, laboratory technicians complete sample preparation activities such as centrifugation before loading the samples into an automated sample processing system. Before loading the samples, the technicians must transfer the samples from sample tubes to containers such as 96 Well Collection Plates or test cartridges and dispense reagents as needed.

The automated sample processing systems have become increasingly large and sophisticated in order to support high sample throughputs for multiple types of assays. As a result, the cost to purchase these systems is typically prohibitive for all except the largest laboratories. Sample preparation requirements for these systems have also become increasingly complex, resulting in an increased chance of errors that can result in degraded sample qualities or sample contamination.

Highly trained technicians are required for many of the in vitro diagnostic tests that are performed using the automated sample processing systems. This is because tests such as the Nucleic Acid Test (NAT) are considered to be high-complexity under the Clinical Laboratory Improvement Amendments (CLIA), and automated sample processing systems that perform these tests have not qualified for CLIA-waived status. The NAT is the preferred test for screening blood or plasma for the presence of human immunodeficiency virus (HIV) and hepatitis C virus (HCV) and for genetic diseases, cancers, bacteria and other viruses.

Another problem with automated sample processing systems is cross-contamination. Cross-contamination problems can be significant for any test protocol that employs amplification techniques such as polymerase chain reaction (PCR). NAT falls into this category. To mitigate cross-contamination, clinical laboratories have had to use separate rooms for reagent preparation, sample preparation, amplification, and post-amplification analysis.

It is desirable to perform in vitro diagnostic testing at the point of care because the complexities involved with storing and shipping samples to a centralized testing laboratory can be avoided. Results can be obtained more quickly for point of care tests which can be a significant advantage in certain situations. Even if automated sample processing systems are available at the point of care, some in vitro diagnostic tests that have not qualified for CLIA-waived status may not be able to be performed if trained technicians are not available.

For these and other reasons, this is a need for the present invention.

### SUMMARY

One aspect of the invention provides a diagnostic test system. The system includes a first layer and a base. The first layer is attached to the base to form one or more chambers. The diagnostic test system includes one or more pumps. Each one of the one or more pumps is configured to control a movement of a fluid within one of the one or more chambers by creating a deformation that changes a volume of the one of the one or more chambers.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a perspective view of one embodiment of a diagnostic test system.

FIG. 2 is a perspective detail view of a portion of the diagnostic test system illustrated in FIG. 1.

FIG. 3 is a perspective detail view of a portion of the diagnostic test system illustrated in FIG. 1.

FIG. 4 is a perspective view of one embodiment of an electrical interface for a diagnostic test system.

FIG. 5 is a block diagram illustrating one embodiment of a diagnostic test system.

FIG. 6 is a cross-sectional view of one embodiment of a diagnostic test system.

FIG. 7 is a top view of one embodiment of the diagnostic test system illustrated in FIG. 6.

FIG. 8 is a cross-sectional view of one embodiment of the diagnostic test system illustrated in FIG. 6.

FIG. 9 is a cross-sectional view of one embodiment of a diagnostic test system.

FIG. 10 is a cross-sectional view of one embodiment of a diagnostic test system.

FIG. 11 is a cross-sectional view of one embodiment of a diagnostic test system.

FIG. 12 is a top view of one embodiment of the diagnostic test system illustrated in FIG. 11.

FIG. 13 is a cross-sectional view of one embodiment of a diagnostic test system.

FIG. 14 is a cross-sectional view of one embodiment of a diagnostic test system.

FIG. 15 is a cross-sectional view of one embodiment of a diagnostic test system.

FIG. 16 is a top view of one embodiment of the diagnostic test system illustrated in FIG. 15.

FIG. 17 is a cross-sectional view of one embodiment of a diagnostic test system.

FIG. 18 is a top view of one embodiment of the diagnostic test system illustrated in FIG. 17.

FIG. 19 is a top view of one embodiment of a diagnostic test system.

FIG. 20 is a top view of one embodiment of a diagnostic test system.

FIG. 21 is a top view of one embodiment of a diagnostic test system.

FIG. 22 is a cross-sectional view of one embodiment of a diagnostic test system.

FIG. 23 is a top view of the diagnostic test system illustrated in FIG. 22.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. It is noted that a base and one or more various layers are set forth as being adjacent to one another in the following Detailed Description. Unless otherwise specified, the base and one or more layers may be directly and physically in contact with each other or a material or one or more other layers may intervene between any of the base and the one or more layers. The following Detailed Description, therefore, is not to be taken in a limiting sense, and the scope of the present invention is defined by the appended claims.

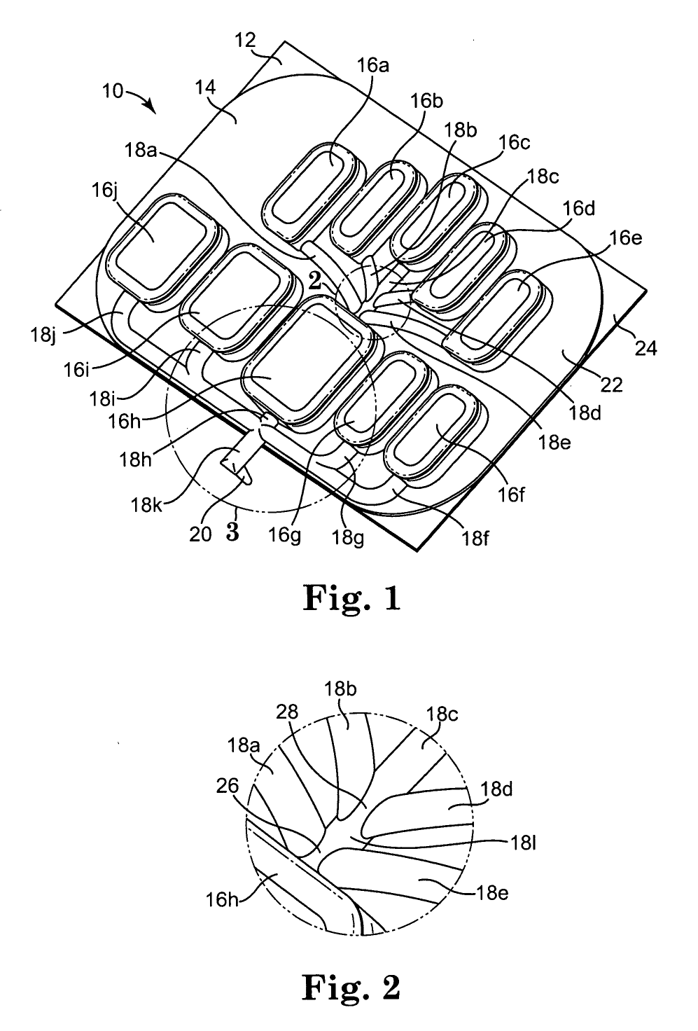

FIG. 1 is a perspective view of one embodiment of a diagnostic test system 10. Diagnostic test system 10 includes a layer 12 and a base 14. Layer 12 is attached to base 14 to form chambers 16a-16j and channels 18a-18k. Each one of the chambers 16a-16j is in fluid communication with one or more other chambers 16a-16j as illustrated in FIG. 1. Each chamber 16 is coupled to and is in fluid communication with one or more channels 18. In the contemplated embodiments, fluid refers to a sample or material, whether a liquid, solid phase, gas or another form, and fluid communication refers to a material, whether a liquid, solid phase, gas or another form, having the capability of passing between any chamber 16 and any one or more other chambers 16, between any channel 18 and any one or more other channels 18, or between any one or more chambers 16 and any one or more channels 18.

In the illustrated embodiment, each chamber 16a through 16j is coupled to and in fluid communication with, respectively, a corresponding channel 18a through 18j. Thus, chamber 16a is coupled to and in fluid communication with channel 18a, chamber 16b is coupled to and in fluid communication with channel 18b etc . . . . The diagnostic test system 10 illustrated in FIG. 1 is one embodiment of an arrangement between chambers 16 and channels 18. In other embodiments, there can be any suitable number of chambers 16 or channels 18, and chambers 16 or channels 18 can be arranged or interconnected in any suitable configuration. In various embodiments, the arrangement of chambers 16 and channels 18 is suitable for completing diagnostic assays or in vitro diagnostic testing on one or more samples. In various embodiments, the dimensions of diagnostic test system 10, the shapes and volumes of any one or more of the chambers 16 and the shapes, cross-sectional sizes and lengths of any one or more of the channels 18 can be set in accordance with the diagnostic testing or tests desired to be performed.

In the illustrated embodiment, diagnostic test system 10 includes a sample input port 20. Sample input port 20 is coupled to and in fluid communication with channel 18k. Port 20 is configured to receive a sample or material that is to be analyzed and provides for entry of the sample into diagnostic test system 10. In various embodiments, the sample can be any suitable solid, fluid or gaseous material that includes an analyte. In these embodiments, suitable samples can include, but are not limited to, cells, tissues, viruses, drugs, bodily fluids such as blood or urine, or ambient air that contains contaminates. Although one port 20 is illustrated in FIG. 1, in other embodiments, two or more ports can be used. In other embodiments, one or more ports 20 can be coupled to any chamber 16 or channel 18. In various embodiments, port 20 can function as an input port, an output port or a bidirectional port. If two or more ports are used, they can each function as input ports, output ports, or bidirectional ports. In one embodiment, port 20 is adapted to be punctured by a needle or syringe to allow for the entry of one or more samples into diagnostic test system 10. In other embodiments, one or more of the ports 20 are configured to receive or expel any one or more samples, fluids or gases.

In other embodiments, one or more of the ports 20 can function as a vent that can release pressure within a chamber 16 or channel 18 that is caused by a fluid, gas or sample. In these embodiments, one or more of the ports 20 is configured to provide an opening to the environment to release a gas or fluid. In some embodiments, port 20 can include a hydrophobic membrane that is configured to pass a gas outside of diagnostic test system 10 while blocking or retaining fluids within a chamber 16 or channel 18. In some embodiments, port 20 can include a hydrophobic membrane that is configured to pass a fluid outside of diagnostic test system 10 while blocking or retaining a gas within a chamber 16 or channel 18. The hydrophobic membranes for these embodiments can be constructed of any suitable material such as a polymer material. In these embodiments, port 20 can function as an input port, an output port or a bidirectional port.

In the illustrated embodiment, diagnostic test system 10 includes one or more actuators that are responsive to one or more electrical signals. The actuators control a movement of one or more fluids to or from at least one of the chambers 16 to conduct a diagnostic test. In various embodiments, the actuators can be one or more pumps that move a fluid into or out of a chamber 16, one or more valves that control the exit or entry of a fluid into or out of a chamber 16. In one embodiment, the valves control the movement of the fluid through one or more of the channels 18 by creating a deformation that changes a cross-sectional area of the one or more of the channels 18. In various embodiments, the actuators can mix one or more fluids within a chamber 16, can vortex one or more fluids within a chamber 16, or can vibrate one or more fluids within a chamber 16. The actuators can perform any suitable function that controls the movement of the fluids or samples within diagnostic test system 10. In the illustrated embodiments, the actuators are incorporated into one or more of the chambers 16 and one or more of the chambers 18. In various embodiments, the actuators can be built into or attached to layer 12, base 14, or to both layer 12 and base 14. The actuators in various embodiments include any suitable device or system that can control the movement of a fluid within diagnostic test system 10.

In some embodiments, the actuators can be electrostatic actuators, electromagnetic actuators, electromechanical actuators or thermal actuators. In these embodiments, the actuators can include a suitable piezoelectric material such as a piezoelectric ceramic or other piezoelectric crystal material. These actuators experience a mechanical displacement or deformation such as a bending or flexing when suitable voltages having suitable polarities are applied.

In some embodiments, the actuators include suitable electroactive polymers that convert an electrical energy into a mechanical motion when a voltage is applied. The electroactive polymers include ionic polymers that are activated via the diffusion or mobility of ions. These electroactive polymers can increase to a desired volume to create displacement or deformation and return to their original volume in response to the application of suitable voltages having suitable polarities. The materials used for these electroactive polymers can include, but are not limited to, polymer-metal composites, conductive polymers, gels, and carbon nanotubes. The electroactive polymers can also include electronic polymers that experience displacement or deformation in the presence of an electric field. The electroactive polymers can include, but are not limited to, electrostrictive, electrostatic, piezoelectric, and ferroelectric polymers. In some embodiments, the actuators include a polymer elastomer dielectric material that is coated on both sides with elastomer conductive films. Application of a voltage between the two films creates an electrostatic force that compresses the polymer material to create the displacement or deformation.

In some embodiments, the actuators move a fluid by using a temperature induced high pressure bubble. In these embodiments, an electrical current is applied to a heater and heat is transferred to a suitable actuation fluid contained within a chamber. When the fluid in the chamber reaches a temperature that is sufficient to cause a vapor bubble to form, the vapor bubble builds up a localized pressure that expands a diaphragm to create a displacement or deformation within a chamber 16. The pressure created by the displacement or deformation of the diaphragm is sufficient to move a fluid within chamber 16.

In the illustrated embodiment, the actuators are coupled to an electrical interface. The actuators are responsive to one or more electrical signals that are provided to the electrical interface and control the movement of fluids to or from the chambers 16 in response to the electrical signals. The electrical signals can be provided by any suitable controller. In various embodiments, the controller can be a computer or microcontrollers that provides suitable sample processing protocols via the electrical signals to diagnostic test system 10. In various embodiments, the controller can be included within diagnostic test system 10 or can be external to diagnostic test system 10.

In the illustrated embodiment, one or more of the chambers 16 can include temperature control devices such as heaters or coolers that are used to increase or decrease the temperature of a fluid within the chambers 16 to a desired value. In some embodiments, the temperature control devices are coupled to the electrical interface. In some embodiments, the temperature control devices can be built into or attached to layer 12, base 14 or to both layer 12 and base 14. In some embodiments, the temperature control devices include one or more heaters that can heat a fluid within one or more of the chambers 16, one or more of the channels 18, or within both chambers 16 and channels 18. In various embodiments, the heaters can be aligned to or be placed in close proximity to chambers 16 to heat a fluid within the chambers 16, or can be aligned to or placed in close proximity to channels 18 to heat a fluid within channels 18. In some embodiments, the heater is constructed from a resistive material that increases in temperature when a current is applied. In these embodiments, the heater is coupled to the electrical interface and the current is provided via the electrical interface. In some embodiments, the heater is constructed from one or more thin metal films that function as a resistor. The electrical current for these and other embodiments can be provided by a power supply, a computer or a microcontroller that is coupled to the heater via the electrical interface. The temperature of the heater can be controlled by varying the amount of current provided to the heater. In some embodiments, one or more of the chambers 16 and/or one or more of the channels 18 include temperature measurement devices that measure a temperature within the chambers 16 or channels 18. In these embodiments, the temperature measurement devices are coupled to a controller such as a computer or microcontroller via the electrical interface, and the controller controls the amount of a current provided to each heater in response to the signals received from the temperature measurement devices.

In the illustrated embodiment, one or more of the chambers 16 can include an optical system that provides for the detection of an analyte. In some embodiments, the optical system includes one or more optical windows that provide for the passage of electromagnetic radiation that can include visible light. In these embodiments, each of the optical windows are aligned to and/or are in proximity to a corresponding chamber 16 to enhance detection of the analyte. In some embodiments, a reaction that occurs within the corresponding chamber 16 and that results in the generation of electromagnetic radiation can be detected by one or more detection sensors positioned outside of the chamber 16 and in proximity to the optical window. In some embodiments, the detection sensors can be incorporated within diagnostic test system 10. In these embodiments, the sensors can be placed in proximity to the optical windows. In some embodiments, the sensors are photodiodes that convert electromagnetic radiation having suitable wavelengths to corresponding electrical signals. The photodiodes are coupled to the electrical interface and transfer the electrical signals to the interface.

In various embodiments, the optical systems include one or more filters and/or one or more mirrors that are configured to enhance detection of an analyte. In these embodiments, the filters and mirrors are aligned to or are in close proximity to a corresponding chamber 16 to enhance detection of the analyte. The filters in these embodiments pass a suitable range of wavelengths. In some embodiments, the photodiodes include the filters that are configured to pass the suitable ranges of wavelengths.

In the embodiments illustrated herein and in other contemplated embodiments, diagnostic test system 10 can be used for any suitable chemical or biochemical test or process. For example, nucleic acid amplification technologies such as polymerase chain reaction (PCR) or ligase chain reaction (LCR) can be performed. Chemical tests such as immunoassay tests can also be performed. The immunoassay tests can include fluorescent immunoassay (FIA) tests that utilize a fluorescent label or an enzyme label that acts to form a fluorescent product. The tests can include chemiluminescent immunoassay (CLIA) tests that utilize a chemiluminescent label to create reactions that produce light. The tests can include immunonephelometry tests that can result in antibody and antigens forming immune complexes that can scatter incident light which can be measured. The tests can include enzyme-linked immunosorbent assay (ELISA) tests that utilize an enzyme to catalyze a color producing reaction. Other immunoassay tests can include immunoprecipitation tests, particle immunoassay tests, radioimmunoassay (RIA) tests or colorimetric tests.

With tests such as immunoassay tests, optical systems that utilize combinations of optical windows, filters or mirrors can be used to detect desired analytes that result from these tests. One or more of the chambers 16 in diagnostic test system 10 can include suitable reagent labels that are used to detect the analytes. Examples of these labels include, but are not limited to, fluorescent labels, chemiluminescent labels, enzyme markers and calorimetric markers. In some embodiments, these labels are preloaded in one or more of the chambers 16 before the diagnostic assay is performed. In some embodiments, the preloading occurs when diagnostic test system 10 is manufactured. In these embodiments, any suitable number of different labels can be preloaded within the chambers 16. This allows diagnostic test system 10 to have the ability to perform different types of diagnostic tests. In other embodiments, the labels are moved to one or more of the chambers 16 using one or more of the actuators, or are transferred to one or more of the chambers 16 using one or more ports 20 that are in fluid communication with the chambers 16.

Referring to FIG. 1, in one exemplary embodiment, chambers 16a, 16b, 16c, 16d and 16e are each configured to hold a reagent, chambers 16f and 16g are configured to hold a solution suitable for an interim process, such as an elution fluid or solvent, chambers 16i and 16j hold wash solutions and/or provide a location for one or more interim processes or reactions, and chamber 16h is a reaction chamber. In other embodiments, one or more of the chambers 16 can be storage chambers that store fluids or materials used for diagnostic testing, or can be waste chambers that store unwanted fluids or materials. In the exemplary embodiment, the reagents can be any suitable chemical substance of sufficient purity for use in diagnostic assays. The reagents can include, but are not limited to, fluorescent labels, chemiluminescent labels, enzyme markers or calorimetric markers. In various embodiments, if PCR amplification is performed, chamber 16f or 16g can hold a lysing reagent. In other embodiments, cell separation for PCR amplification occurs external to diagnostic test system 10. In other embodiments, one or more of the chambers 16 can include suitable solids or filtering for capturing a desired analyte from a sample or fluid.

In the embodiment illustrated in FIG. 1, layer 12 is formed from a first flexible layer or material. Base 14 has a side 22 and an opposing side that is bonded to a side 24 of layer 12. Layer 12 is bonded to base 14 to seal one or more open areas in base 14 to form the chambers 16 and channels 18. In other embodiments, chambers 16 and channels 18 can be contained wholly within layer 12, base 14, or both layer 12 and base 14. In various embodiments, base 14 can be formed from materials that are more flexible, have the same flexibility, or have lesser flexibility than layer 12. In the illustrated embodiment, base 14 is formed from a substantially rigid material.

In other embodiments, a second layer can be attached to side 22 of base 14. In these embodiments, one or more of the chambers 16 and one or more of the channels 18 are open on side 22. The second layer is attached to side 22 of base 14 to seal the open areas. In these embodiments, first layer 12 and the second layer seal both sides of base 14 to form the chambers 16 and the channels 18.

In the embodiment illustrated in FIG. 1, layer 12 is manufactured from a flexible or elastic material and base 14 is manufactured from a material that is substantially rigid. Base 14 can be formed from materials that can include, but are not limited to, polyester, polypropylene, polyethylene, polystyrene, polyurethane, polyvinyl chloride, polyvinylidene chloride and polycarbonate. In some embodiments, the use of injection molded plastic materials allows recessed regions that define part or all of chambers 16 and channels 18 to be easily formed. In other embodiments, any suitable metal can be used. Suitable metals can include metals used to manufacture leadframe packages for semiconductor applications. These metals include, but are not limited to, copper (Cu), iron (Fe) and zinc (Zn). In some embodiments, base 14 can be formed from or can include a printed circuit board. Suitable printed circuit boards can include, but are not limited to, copper-clad epoxy-glass laminates. In some embodiments, the printed circuit boards include signal conductors that are used to couple electrical signals between external controllers or instruments and circuits or devices such as actuators that are contained within diagnostic test system 10. In some embodiments, base 14 is formed from one or more flexible circuits or includes one or more flexible circuits. In these embodiments, the flexible circuits can be manufactured using any suitable technology that includes forming electronic devices on flexible substrates. The flexible circuits can be manufactured using any suitable material such as plastic. In various embodiments, base 14 is manufactured from materials that are inert to fluids within diagnostic test system 10. In some embodiments, one or more of the chambers 16 and one or more of the channels 18 are coated with materials or compositions that are inert to the fluids. These materials or compositions include, but are not limited to, gold or silicone epoxy.

In the illustrated embodiment, layer 12 can be formed from materials that have elastomeric properties. These materials include, but are not limited to, polyester, polypropylene, polyethylene, polystyrene, polyurethane, polyvinyl chloride, polyvinylidene chloride and polycarbonate. In other embodiments, layer 12 can be formed from or can include one or more flexible circuits. The flexible circuits can be manufactured using any suitable technology or materials. Layer 12 can be manufactured from any material that is inert to fluids. Also, layer 12 can be coated with materials or compositions that are inert to fluids. The materials or compositions that can be used to coat layer 12 include, but are not limited to, gold or silicone epoxy.

FIG. 2 is a perspective detail view of a portion of the diagnostic test system illustrated in FIG. 1. The portion illustrated in FIG. 2 is indicated at 2 in FIG. 1. In this embodiment, channels 18a and 18e meet at a common channel portion 26, and channels 18b, 18c and 18d meet at a common channel portion 28. Common channel portion 26 and common channel portion 28 are joined by channel 18l. In one embodiment, any fluids passing through any of channels 18a, 18b, 18c, 18d or 18e can pass through common channel portions 26 and 28 and channel 18l without restriction. In other embodiments, any one or more of the channels 18a, 18b, 18c, 18d, 18e, 18l, common channel portion 26 or common channel portion 28 can include actuators. In one embodiment, the actuators are valves that are configured to control a movement of a fluid between one or more of the channels 18a, 18e or 18l and common channel portion 26. In one embodiment, the valves are configured to control a movement of a fluid between one or more of the channels 18b, 18c, 18d or 18l and common channel portion 28.

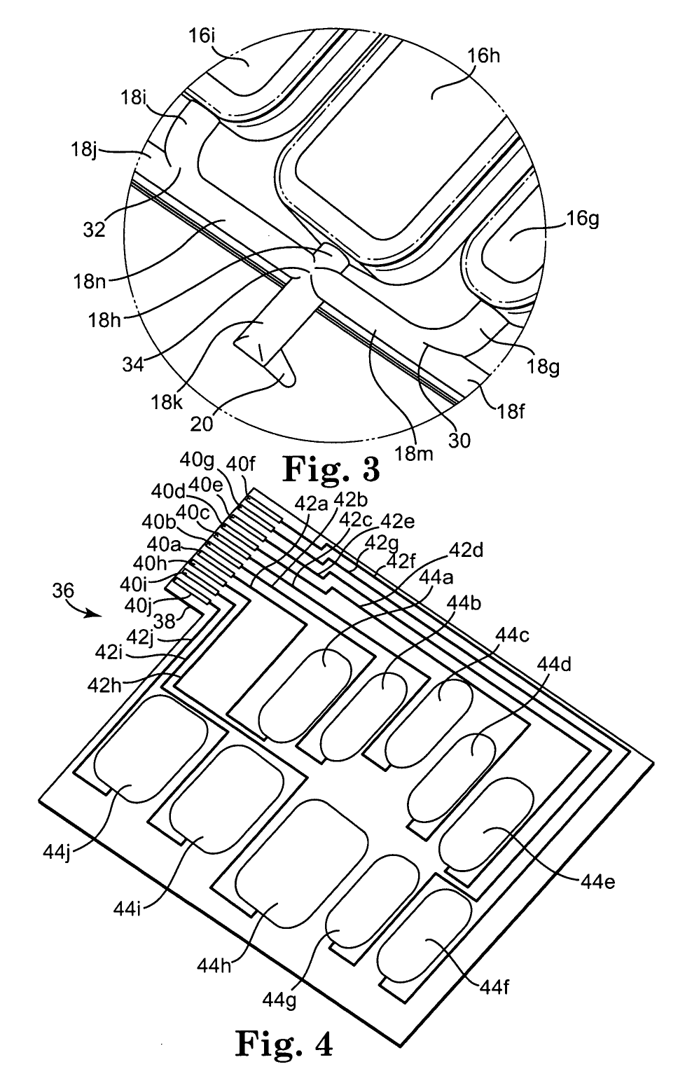

FIG. 3 is a perspective detail view of a portion of the diagnostic test system illustrated in FIG. 1. The portion illustrated in FIG. 3 is indicated at 3 in FIG. 1. In this embodiment, channels 18f, 18g and 18m meet at a common channel portion 30, channels 18i, 18j and 18n meet at a common channel portion 32, and channels 18h, 18k, 18m and 18n meet at a common channel portion 34. Common channel portion 30 and common channel portion 34 are joined by channel 18m, and common channel portion 32 and common channel portion 34 are joined by channel 18n. In one embodiment, any fluids passing through any of the channels 18f, 18g, 18h, 18i, 18j 18k, 18m and 18n can pass through common channel portions 30, 32 and 34 without restriction. In other embodiments, any one or more of the channels 18f, 18g, 18h, 18i, 18j 18k, 18m, 18n, or common channel portions 30, 32 or 34 can include actuators. In one embodiment, the actuators are valves that are configured to control a movement of a fluid between one or more of the channels 18f, 18g or 18m and common channel portion 30. In one embodiment, the valves are configured to control a movement of a fluid between one or more of the channels 18i, 18j or 18n and common channel portion 32. In one embodiment, the valves are configured to control a movement of a fluid between one or more of the channels 18h, 18k, 18m or 18n and common channel portion 34.

FIG. 4 is a perspective view of one embodiment of an electrical interface for a diagnostic test system 10. The electrical interface is illustrated generally at 36. Electrical interface 36, hereinafter referred to as layer 36, represents an embodiment of layer 12 that includes electrical conductors that are adapted to couple electrical signals to suitable devices that are contained within diagnostic test system 10. These devices can include, but are not limited to, actuators such as pumps or valves or other devices such as sensors or heaters.

In the embodiment illustrated in FIG. 4, layer 36 includes a connector 38 with conductive pads 40a-40j. Each conductive pad 40a-40j is electrically coupled to a respective conductive trace 42a-42j, and each trace 42a-42j is routed to respective chamber portions at 44a-44j, respectively. Pads 40 and traces 42 can be manufactured using any suitable conductive material such as copper. In this embodiment, layer 36 is attached to base 14 to form chambers 16a-16j and channels 18a-18m, and each chamber portion 44a-44j covers a corresponding cavity within base 14 to form complete corresponding chambers 16a-16j. In the illustrated embodiment, traces 42 are each shown as being routed to a peripheral area of corresponding chamber portions 44. In different embodiments, the traces can be routed to any suitable area around, within or away from chamber portions 44, depending on the location of devices that the corresponding traces 42 are being routed to. In some embodiments, one or more traces 42 are routed to central portions of chamber portions 44 to couple to actuators such as pumps that are located within chambers 16. In some embodiments, one or more traces 42 are routed to locations within chamber portions 44 that are in proximity to areas where chambers 16 couple to and are in fluid communication with channels 18. In these embodiment, the traces 42 couple to actuators that are valves and that are located in chambers 16 and/or in channels 18. In some embodiments, one or more traces 42 are routed to locations that are in proximity to channels 18. In these embodiment, the traces 42 couple to actuators such as pumps or valves that are located in channels 18. In different embodiments, the actuators including the pumps or the valves can be attached to layer 36, base 14, or to both layer 36 and base 14. Although a single pad 40 and trace 42 are illustrated as being coupled to or routed to each chamber portion 44, in other embodiments, no traces or any suitable number of traces can be routed to each chamber portion 44, chamber 16, channel 18 or other suitable area within diagnostic test system 10.

In other embodiments, the electrical interface that includes pads 40a-40j and traces 42a-42j can have other suitable forms. In these embodiments, pads 40 can be located in any suitable area of layer 36 such as in an interior region of layer 36. While pads 40 and traces 42 are illustrated as being routed on a single or first layer, in other embodiments, pads 40 and traces 42 can be routed on multiple layers of layer 36 such as on either side of layer 36, within interior regions of layer 36, or on one or both sides of layer 36 and within interior regions of layer 36. In one embodiment, traces 42 are routed on both sides of layer 36 and within one or more interior planar regions of layer 36 thereby forming three or more layers of traces 42. In other embodiments, pads 40 and/or traces 42 can be located on or within base 14 or on or within both layer 36 and base 14. Any of these embodiments can include one or more vias that interconnect any desired traces 42 routed on multiple layers of layer 36, routed on multiple layers of base 14, or routed on multiple layers of both layer 36 and base 14.

In the embodiment illustrated in FIG. 4, traces 42 are routed around chambers 16 and channels 18 so as to avoid contact with fluids within interior portions of chambers 16 and channels 18. In other embodiments, traces 42 are coated with suitable materials such as gold or silicon epoxy that make traces 42 inert to any fluids within chambers 16 or channels 18. In some embodiments, traces 42 can be routed over interior portions of chambers 16 and/or channels 18. In various embodiments, layer 36 can be manufactured using materials that include those used in the embodiments of layer 12. In various embodiments, layer 36 can be manufactured using any suitable printed circuit board or flexible technology including surface mount or through-hole technologies.

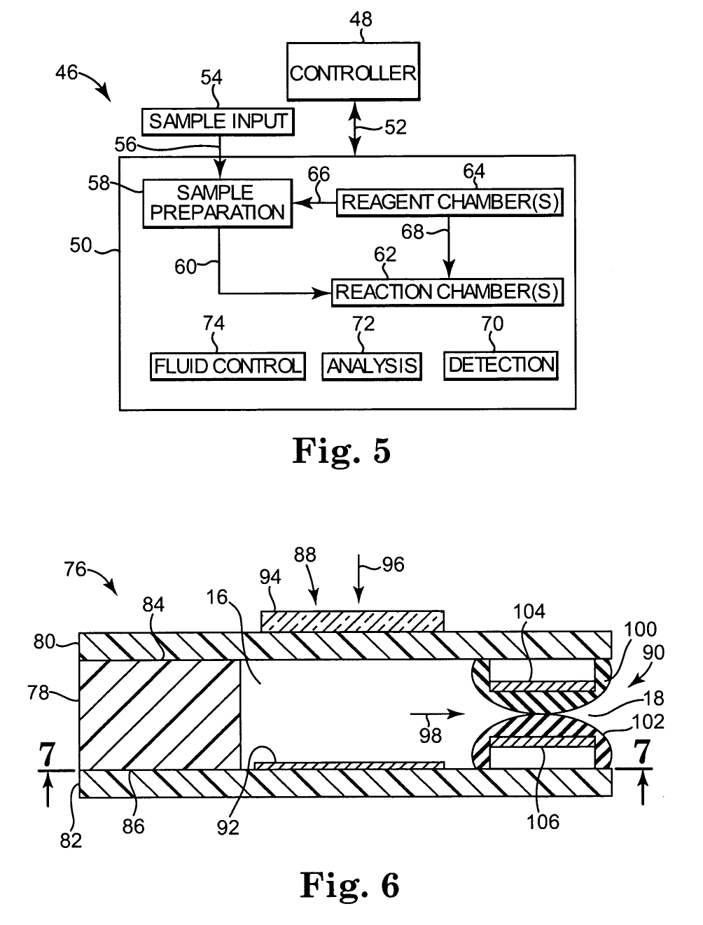

FIG. 5 is a block diagram illustrating one embodiment of a diagnostic test system. The block diagram is illustrated generally at 46 and is a functional representation of a diagnostic test system 10 that is coupled to a controller. In the representation in FIG. 5, controller 48 is coupled to diagnostic test system 50 via path 52. Path 52 electrically couples controller 48 to an electrical interface of diagnostic test system 50. In one embodiment, path 52 is an electrical connection from controller 48 that couples to a connector 38 of electrical interface 36. Path 52 allows one or more signals to be communicated between controller 48 and diagnostic test system 50

In the illustrated embodiment, a sample is provided at block 54 to diagnostic test system 50 via path 56. In various embodiments, any suitable input such as one or more ports 20 can be used to provide the sample to diagnostic test system 50. Sample preparation can be performed at block 58 before moving the sample to one or more reaction chambers at 62 via path 60. Sample preparation is performed in one or more chambers 16. Any suitable solution such as an elution fluid or solvent that is desired for sample preparation can be transferred from one or more reagent chambers at block 64 via path 66. The reagent chambers include one or more chambers 16. In various embodiments, the solutions for sample preparation can be preloaded in the reagent chambers at 64. In one exemplary embodiment, PCR amplification is performed and a lysing reagent is transferred from a chamber 16 at block 64 to another chamber 16 at block 58. In other embodiments, sample preparation is not performed and the sample is moved from the sample input at block 54 to one or more of the chambers 16 at block 62.

One or more reagents at block 64 are provided via path 68 to the reaction chambers at block 62. In various embodiments, one or more reagents can be preloaded in one or more chambers 16. The reagents and sample react with each other at block 62 and create a chemical reaction that can be detected via block 70. While detection via block 70 is illustrated as occurring within diagnostic test system 50, in other embodiments, block 70 is located outside of diagnostic test system 50 and detection occurs outside of diagnostic test system 50. In some embodiments, the detection performed at block 70 occurs within controller 48. In some embodiments, analysis of the detected results can be performed at block 72 within diagnostic test system 50 using suitable devices such as microcontrollers or microprocessors. In other embodiments, the analysis function of block 72 is performed by controller 48.

In the embodiment illustrated in FIG. 5, the fluid control functions are controlled by block 74. In various embodiments, block 74 controls fluid movements to or from one or more of the blocks 58, 62 and 64, or through any one or more of the paths 56, 60, 66 and 68. In various embodiments, the fluid control includes, but is not limited to, control of actuators such as pumps or valves, control of temperatures of fluids or samples via devices such as heaters or coolers, and preparation of fluids via suitable methods that include mixing, shaking or creation of a fluid vortex. In various embodiments, the fluid control functions are accomplished by providing one or more electrical signals to one or more actuators to control a movement of one or more fluids from at least one of the chambers 16.

FIG. 6 is a cross-sectional view of one embodiment of a diagnostic test system. The diagnostic test system is shown generally at 76. Diagnostic test system 76 represents another embodiment of diagnostic test system 10 and includes a base 78, a first layer 80 and a second layer 82. Base 78 can be formed from suitable materials in different embodiments. These materials include the materials used to manufacture base 14. First layer 80 and second layer 82 can be formed from suitable materials in different embodiments. These materials include the materials used to manufacture layer 12. In the illustrated embodiment, first layer 80 and second layer 82 are formed from elastomeric materials and base 78 is formed from a material that is more rigid than first layer 80 or second layer 82. In other embodiments, first layer 80 and second layer 82 can each be formed from materials that are as rigid as base 78, or that are more rigid than base 78.

In the embodiment illustrated in FIG. 6, base 78 includes one or more open areas that include portions of chamber 16 and channels 18. Layer 80 is bonded to a first side of base 78 at a surface 84, and layer 82 is bonded to a second side of base 78 at a surface 86. First layer 80 and second layer 82 cooperatively seal the open areas within base 78 to form chamber 16 and channel 18. While only one chamber 16 and one channel 18 are illustrated, in other embodiments, there can be any suitable number of chambers 16 and channels 18. In other embodiments, chamber 16 and channel 18 can have any suitable shape or size.

In the illustrated embodiment, diagnostic test system 76 includes a pump 88, a valve 90 and a heater 92. Diagnostic test system 76 also includes an electrical interface (not shown) that is coupled to pump 88, valve 90 and heater 92. In various embodiments, the electrical interface can be located in or on base 78, first layer 80 or second layer 82. Pump 88 is aligned with chamber 16 and can be activated to move a fluid out of chamber 16 in response to one or more signals that are provided via the electrical interface to pump 88. Valve 90 seals a fluid in chamber 16 when in a closed position as illustrated in FIG. 6, and allows fluid to pass when pump 88 is activated. Heater 92 is coupled to the electrical interface and is configured to raise a temperature of a fluid within chamber 16 in response to one or more signals that are provided to heater 92 via the electrical interface.

Pump 88 includes actuator element 94. In various embodiments, actuator element 94 can be located on either side or within first layer 80. In various embodiments, actuator element 94 can be made from any suitable material that exhibits a mechanical distortion when a signal is applied. The mechanical distortion can include flexing or bending and the signal can include a voltage or a current. In the illustrated embodiment, actuator element 94 is attached to first layer 80. When a voltage is applied via the electrical interface, actuator element 94 and first layer 80 bend in a direction of arrow 96 and create a pressure in chamber 16 that is sufficient to push a fluid in chamber 16 in the direction of arrow 98 towards valve 90. When the voltage is removed, actuator element 94 and first layer 80 return to their original shape or position. The amount of pressure created in chamber 16 can be controlled by applying suitable voltages having suitable polarities to actuator element 94.

Valve 90 includes an upper portion 100 and a lower portion 102. In one embodiment, valve 90 controls the movement of a fluid through channel 18 by creating a deformation that changes a cross-sectional area of channel 18. In the illustrated embodiment, upper portion 100 and lower portion 102 are manufactured from a suitable elastomeric material. Actuator element 104 is attached to an interior surface of upper portion 100 and actuator element 106 is attached to an interior surface of lower portion 102. In other embodiments, actuator element 104 can be in other suitable locations within or on upper portion 100, and actuator element 106 can be in other suitable locations within or on lower portion 102. In other embodiments, upper portion 100 does not include actuator element 104 and/or lower portion 102 does not include actuator element 106. Other embodiments do not include upper portion 100 and actuator element 104, or lower portion 102 and actuator element 106. In various embodiments, actuator element 104 and actuator element 106 can be made from any suitable material that exhibits a mechanical distortion when a signal is applied. The mechanical distortion can include flexing or bending and the signal can include a voltage or a current.

In the illustrated embodiment, upper portion 100 and lower portion 102 are shown as resiliently biased in a closed position thereby preventing a fluid from entering or leaving chamber 16. Actuator element 104 and actuator element 106 are coupled to the electrical interface. When a voltage is applied to actuator elements 104 and 106 via the electrical interface, actuator elements 104 and 106 bend and separate upper portion 100 and lower portion 102 to an open position that is sufficient to allow a fluid to pass through valve 90. When the voltage is removed, actuator elements 104 and 106 return to their original shape or position. In various embodiments, valve 90 can operate between closed and fully open positions to maximize a fluid throughput, or can operate between a closed position and any suitable numbers of open positions ranging from fully open to almost closed in order to regulate the amount of fluid that is allowed to pass through valve 90.

In one embodiment, upper portion 100 and lower portion 102 are made from an elastomeric material and are resiliently biased in a closed position to prevent a fluid from leaking out. When a voltage is applied via the electrical interface to actuator element 94, actuator element 94 and first layer 80 bend and create a suitable pressure within chamber 16 that is sufficient to force the fluid through upper portion 100 and lower portion 102 in the direction of arrow 98.

In various embodiments, actuator elements 94, 104 or 106 can be made from any suitable piezoelectric material such as a piezoelectric ceramic or other piezoelectric crystal material. In these embodiments, actuator elements 94, 104 or 106 bend when a voltage is applied to produce the mechanical displacement or deformation. Varying the voltage can vary the amount of bending of actuator elements 94, 104 or 106. The bending of any of actuator elements 94, 104 or 106 causes the corresponding first layer 80, upper portion 100 or lower portion 102 to deform and provide the desired actuation result. In some embodiments, actuator elements 94, 104 or 106 are made from two or more piezoelectric elements and differential changes in length of the two or more elements is amplified to produce relatively larger amounts of bending. In some embodiments, piezoelectric elements are connected in series and a displacement or deformation of each element adds to an overall desired displacement or deformation.

In various embodiments, actuator elements 94, 104 or 106 can include suitable electroactive polymer materials that convert and electrical energy into a mechanical motion when a voltage is applied. In these embodiments, the amount of displacement or deformation of actuator elements 94, 104 or 106 can be controlled by application of suitable voltages having suitable polarities.

In some embodiments, the displacement or deformation of actuator elements 94, 104 or 106 is caused by application of suitable voltages having suitable polarities to the electroactive polymers that creates an electrochemical effect. In these embodiments, the electroactive polymers are ionic polymers that are activated via the diffusion or mobility of ions. The materials used for these electroactive polymers can include, but are not limited to, polymer-metal composites, conductive polymers, gels, and carbon nanotubes. These electroactive polymers can increase to any suitable volume and return to their original volume in response to application of the voltages.

In some embodiments, the displacement or deformation of actuator elements 94, 104 or 106 is caused by application of suitable voltages having suitable polarities to the electroactive polymers that creates displacement or deformation in the presence of an electric field. In these embodiments, the electroactive polymers are electronic polymers that include, but are not limited to, electrostrictive, electrostatic, piezoelectric, and ferroelectric polymers. In some embodiments, actuator elements 94, 104 or 106 include a polymer elastomer dielectric material that is coated on both sides with elastomer conductive films. Application of a voltage between the two films creates an electrostatic force that compresses the polymer material. The volume of the polymer material does not change so that compression of the polymer material in one direction causes the polymer material to expand in one or more other directions in order to maintain the volume at a constant. This expansion creates the displacement or deformation.

In the illustrated embodiment, actuator elements 94, 104 or 106 have a bilayer construction and are formed from a layer of an electroactive polymer material that is attached to a layer of material that does not change its volume when a voltage is applied. The displacement or deformation of the electroactive polymer causes actuator elements 94, 104 or 106 to bend. The amount of bending of actuator elements 94, 104 or 106 can be controlled by application of suitable voltages having suitable polarities. In various embodiments, the electroactive polymers can be ionic polymers, electronic polymers or other suitable types of electroactive polymers.

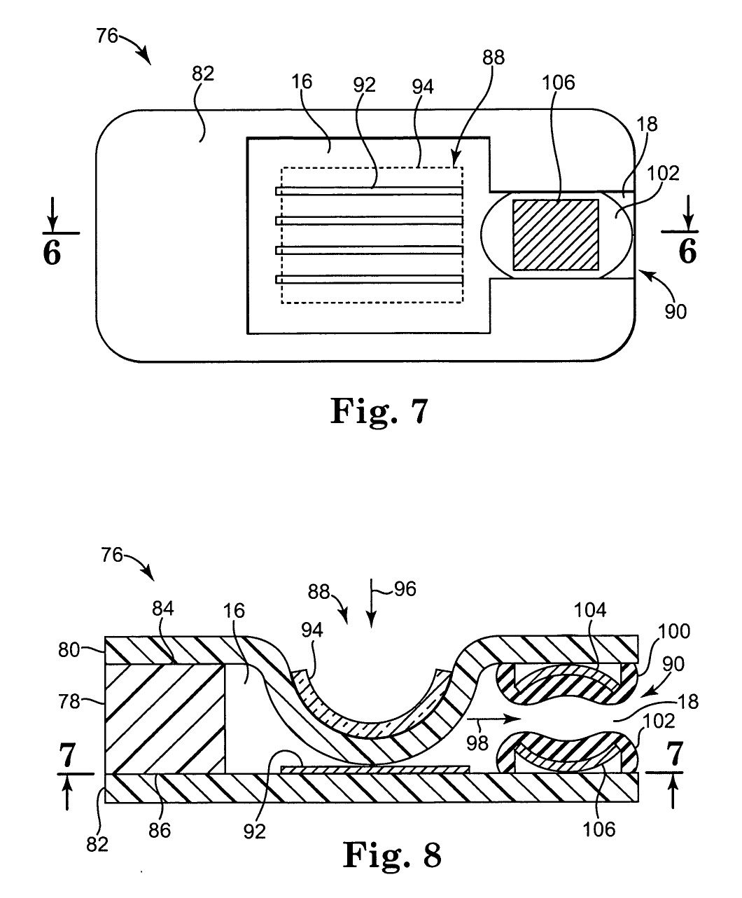

FIG. 7 is a top view of one embodiment of the diagnostic test system 76 illustrated in FIG. 6. The location of actuator element 94 is shown by a dashed line. In this embodiment, actuator element 94 and heater 92 are centered within or aligned to chamber 16. Actuator 106 is contained within lower portion 102 and is centered within or aligned to channel 18. In other embodiments, actuator element 94 or heater 92 are not aligned to chamber 16. In other embodiments, actuator 106 is not aligned to channel 18. The relative sizes, shapes and dimensions of chamber 16, channel 18, actuators 94 and 106, heater 92 and lower portion 102 are for illustrative purposes and can be other suitable sizes, shapes and dimensions in other embodiments.

FIG. 8 is a cross-sectional view of one embodiment of the diagnostic test system 76 illustrated in FIG. 6. In this embodiment, pump 88 and valve 90 are in an activated state. Actuators 94, 104 and 106 are coupled to the electrical interface and are configured to receive one or more signals from the electrical interface. These signals include voltages having suitable magnitudes and polarities that are sufficient to activate pump 88 and valve 90.

Pump 90 includes actuator element 94 which is attached to first layer 80. In this embodiment, first layer 80 functions as a diaphragm. The voltage provided to actuator element 94 causes actuator element 94 and first layer 80 to bend in the direction of arrow 96 and create a pressure in chamber 16 that is sufficient to push a fluid in chamber 16 in the direction of arrow 98 towards valve 90. In various embodiments, when the voltage is changed or removed from actuator element 94, actuator element 94 and first layer 80 return to their original shape or position as illustrated in FIG. 6.

When valve 90 is not activated, valve 90 is in a closed position and seals a fluid in chamber 16 and/or keeps a fluid out of chamber 16. Valve 90 is illustrated in FIG. 8 in an activated or open position and fluid is able to pass in the direction of arrow 98. Actuator element 104 and actuator element 106 are coupled to the electrical interface and receive one or more signals. In this embodiment, the signals are voltages that cause actuator elements 104 and 106 to bend and separate upper portion 100 and lower portion 102 sufficiently to allow the fluid to pass. In various embodiments, when the voltage is changed or removed from actuator elements 104 and 106, upper portion 100 and lower portion 102 are resiliently biased in the closed position as illustrated in FIG. 6, thereby preventing remaining fluid (if any) from leaving chamber 16 or any fluids from entering chamber 16.

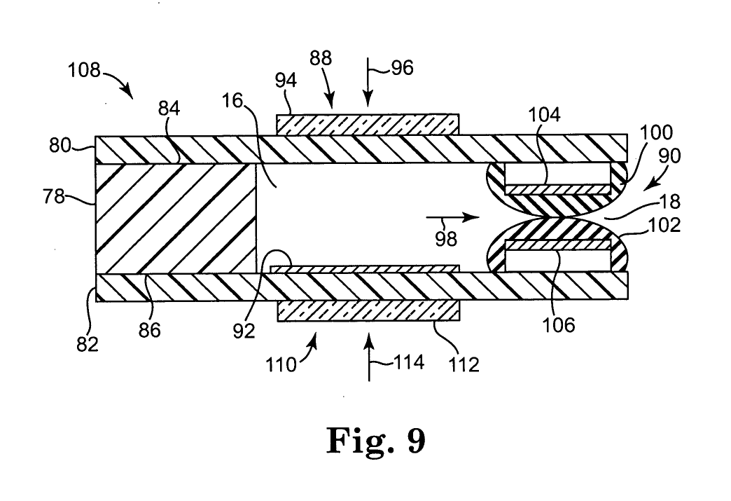

FIG. 9 is a cross-sectional view of one embodiment of a diagnostic test system. The diagnostic test system is illustrated generally at 108. This embodiment is similar to diagnostic test system 76 and includes a second pump illustrated at 110. Pump 110 is coupled to the electrical interface and is aligned to chamber 16. Pump 110 is activated at the same time as pump 88 and operates cooperatively with pump 88 to move a fluid out of chamber 16 in response to one or more signals that are provided via the electrical interface. Pump 110 includes actuator element 112. In various embodiments, actuator element 112 can be located on either side or within second layer 82. In various embodiments, actuator element 112 can be made from any suitable material that exhibits a mechanical distortion when a signal is applied. Suitable signals include a voltage or a current. In the illustrated embodiment, actuator element 112 is attached to second layer 82. When suitable voltages are applied via the electrical interface to pump 88 and pump 110, actuator element 94 and first layer 80 bend in the direction of arrow 96, and actuator element 112 and second layer 82 bend in the direction of arrow 114. This creates a pressure within chamber 16 that is sufficient to push a fluid in chamber 16 in the direction of arrow 98 towards valve 90. In this embodiment, heater 92 is sufficiently flexible to allow second layer 82 to bend with actuator element 112. When the voltages are changed or removed, actuator element 94 and first layer 80 and actuator element 112 and second layer 82 return to their original shape or position. The amount of pressure created within chamber 16 can be controlled by applying suitable voltages to actuator elements 94 and 112. Embodiments of actuator element 112 include the embodiments described or contemplated for actuator element 94. Valve 90 seals a fluid in chamber 16 when in the closed position as illustrated in FIG. 9, and allows a fluid to pass when in an open position as illustrated in FIG. 8.

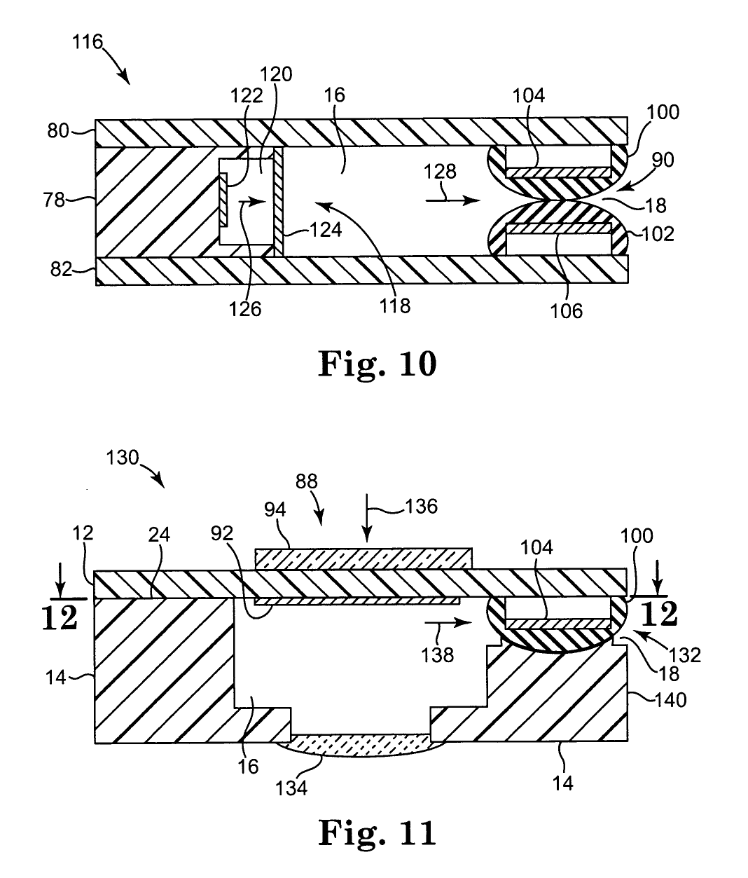

FIG. 10 is a cross-sectional view of one embodiment of a diagnostic test system. The diagnostic test system is shown generally at 116. Diagnostic test system 116 includes valve 90 and a pump 118. Pump 118 includes a fluid chamber 120, a heater 122 and an elastomeric diaphragm 124. Heater 122 can be constructed using any suitable approach and includes the embodiments disclosed for heater 92. In one embodiment, heater 122 includes one or more resistive elements. In the illustrated embodiment, heater 122 is coupled to the electrical interface (not shown). When an electrical current is applied to heater 122 via the electrical interface, heat is transferred to a suitable actuation fluid contained within chamber 120. When the fluid in chamber 120 reaches a temperature that is sufficient to cause a vapor bubble to form, the vapor bubble builds up a localized pressure within chamber 120 that expands diaphragm 124 and creates a displacement or deformation in the direction of arrow 126. The pressure created by the displacement or deformation of diaphragm 124 is sufficient to push a fluid in chamber 16 in the direction of arrow 128 towards valve 90. Valve 90 seals the fluid in chamber 16 when in the closed position as illustrated in FIG. 10, and allows a fluid to pass when in an open position as illustrated in FIG. 8. When the current is reduced or removed from heater 122, chamber 120 cools sufficiently to allow the vapor bubble to collapse and the fluid in chamber 120 to revert back to a liquid state.

In various embodiments, chamber 120 can be coupled to and in fluid communication with one or more channels 18 or chambers 16. Chamber 120 can be coupled to an external port that is used to provide the actuation fluid to chamber 120. In various embodiments, the electrical current supplied to heater 122 can be varied to control the amount of displacement or deformation of diaphragm 124 thereby controlling the amount of pressure created within chamber 16. The relative sizes, shapes and dimensions of fluid chamber 120, heater 122, diaphragm 124, chamber 16, channel 18 or valve 90 are illustrative and can be other suitable sizes, shapes and dimensions in other embodiments. Although pump 118 is illustrated is being contained within base 78, in other embodiments, pump 118 can be built into first layer 80, second layer 82, or any combination of base 78, first layer 80 or second layer 82. Although one pump 118 is illustrated in chamber 16, in other embodiments, two or more pumps 118 can be contained within a chamber 16.

FIG. 11 is a cross-sectional view of one embodiment of a diagnostic test system. The diagnostic test system is shown generally at 130. Diagnostic test system 130 represents another embodiment of diagnostic test system 10 and includes a layer 12 and a base 14. Layer 12 and base 14 are attached to form a chamber 16 and a channel 18.

The materials and embodiments of layer 12 and base 14 include those disclosed in FIGS. 1-4. In various embodiments, base 14 can be formed from materials that are more flexible, have the same flexibility, or have a lesser flexibility than layer 12. In the illustrated embodiment, base 14 is formed from a substantially rigid material and layer 12 is formed from a flexible material. In other embodiments, diagnostic test system 130 can be formed from base 78, first layer 80 and second layer 82.

In the illustrated embodiment, diagnostic test system 130 includes a pump 88, a heater 92, a valve 132 and an optical window 134. Diagnostic test system 130 also includes an electrical interface (not shown) that is coupled to pump 88, heater 92 and valve 132. Pump 88 is aligned with chamber 16 and can be activated to move a fluid out of chamber 16 in response to one or more signals that are provided via the electrical interface. Valve 132 seals a fluid in chamber 16 when in a closed position as illustrated in FIG. 11, and allows the fluid to pass when pump 88 is activated. Pump 88 is illustrated in an activated state in FIG. 8. In one embodiment, valve 132 controls the movement of a fluid through channel 18 by creating a deformation that changes a cross-sectional area of channel 18. In the illustrated embodiment, heater 92 is coupled to the electrical interface and is configured to raise a temperature of a fluid within chamber 16 in response to one or more signals that are provided to the electrical interface. The embodiments of pump 88, heater 92 and the electrical interface include those disclosed in FIGS. 1-10.

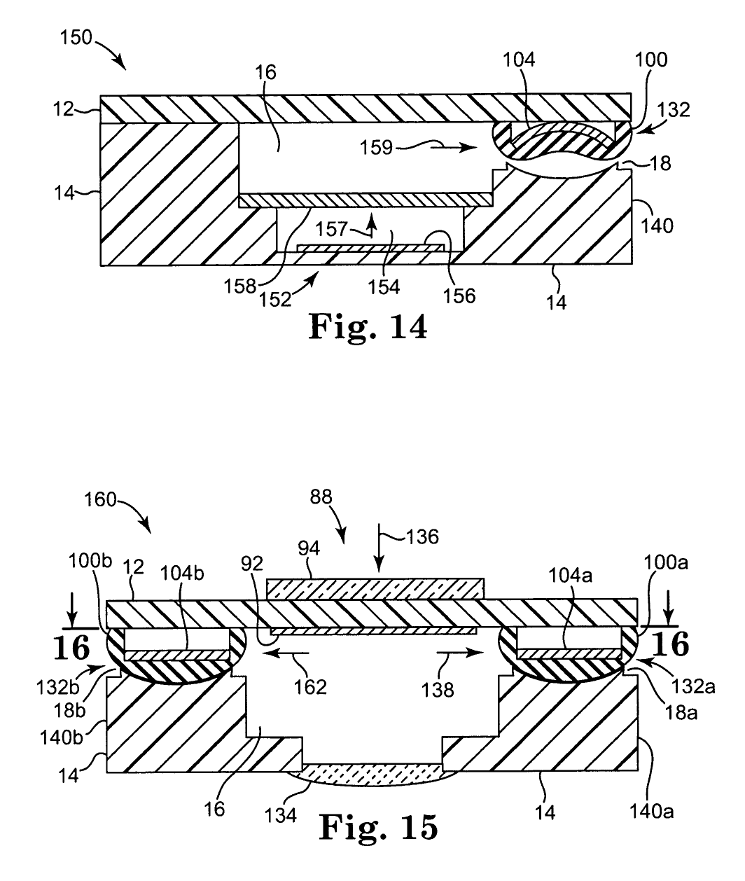

Valve 132 includes an upper portion 100 and a lower portion 140. In the illustrated embodiment, upper portion 100 is manufactured from a suitable elastomeric material and lower portion 140 is formed within base 14. When valve 132 is in a closed position as illustrated in FIG. 11, upper portion 100 is resiliently biased against lower portion 140 thereby preventing a fluid from entering or leaving chamber 16. Actuator element 104 is coupled to the electrical interface. Valve 132 is in an open position as illustrated in FIG. 14 when a suitable voltage having a suitable polarity is applied to actuator element 104 via the electrical interface. The voltage causes actuator element 104 to bend and separate upper portion 100 and lower portion 140 sufficiently to allow the fluid to pass through valve 132. When the voltage is changed or removed, actuator element 104 returns to its original shape or position. In various embodiments, valve 132 can operate between closed and fully open positions to maximize a fluid throughput, or can operate between a closed position and any suitable number of open positions ranging from fully open to almost closed in order to regulate the amount of fluid that passes through valve 132 when pump 88 is activated.

In the illustrated embodiment, optical window 134 facilitates the detection of an analyte. In various embodiments, optical window 134 provides for the passage of electromagnetic radiation that can include visible light. In the illustrated embodiment, optical window 134 is manufactured using any suitable material that is optically transparent. These materials include, but are not limited to, polypropylene and polycarbonate materials or glass.

In the illustrated embodiment, optical window 134 is aligned to chamber 16. In various embodiments, optical window 134 can be used to monitor the progress of a reaction within chamber 16 or to monitor a reaction within chamber 16 that provides a result such as for detection of a desired analyte. A reaction occurring within chamber 16 that results in the generation of electromagnetic radiation having suitable wavelengths can be detected outside of chamber 16. For example, when suitable labels are used in various embodiments, optical window 134 can be used to observe desired analytes that result from reactions within chamber 16. Diagnostic tests that can be performed by diagnostic test system 130 include, but are not limited to, FIA tests that utilize a fluorescent label or an enzyme label to produce a fluorescent product, CLIA tests that utilize a chemiluminescent label to create reactions that produce light or ELISA tests that utilize an enzyme that catalyzes a color producing reaction.

In other embodiments, diagnostic test system 130 includes one or more filters and/or one or more mirrors. In these embodiments, the filters and mirrors are aligned to and/or are in close proximity to chamber 16 to enhance the detection of analytes. The filters in various embodiments pass suitable wavelengths or ranges of wavelengths that can be detected outside of chamber 16. The filters can include optical filters or other filters such as band pass filters or interference filters. In some embodiments, the detection of the analyte is accomplished by external instruments through an exchange of electromagnetic radiation. In some embodiments, diagnostic test system 130 and/or a controller or external instrument include one or more light emitting diodes and detectors such as photodiodes for detecting the presence of or changes in electromagnetic radiation. In some embodiments, the filters can be used to measure luminescence or fluorescence at suitable wave lengths. Suitable electromagnetic frequencies provided by diagnostic test system 130 or by an external instrument can also be used in various embodiments to initiate or induce chemical reactions within chamber 16 or enhance or excite reaction products within chamber 16 for detection.

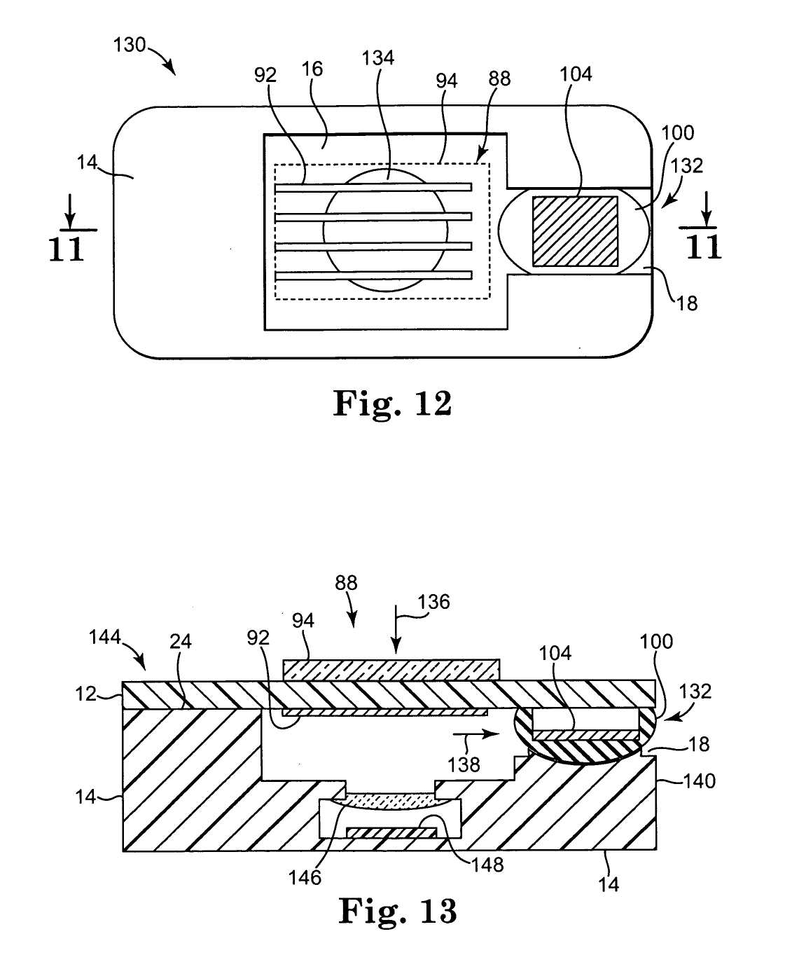

FIG. 12 is a top view of one embodiment of the diagnostic test system 130 that is illustrated in FIG. 11. The location of actuator element 94 is shown by a dashed line. In this embodiment, actuator element 94 and heater 92 are centered within or aligned to chamber 16. Actuator element 104 is contained within upper portion 100 and is centered within or aligned to channel 18. In other embodiments, actuator element 94 or heater 92 are not aligned to chamber 16. In other embodiments, actuator element 104 is not aligned to channel 18. Optical window 134 is centered within or aligned to chamber 16 to enhance detection of a desired analyte. In other embodiments, optical window 134 is not centered to chamber 16 and is located within any suitable area of chamber 16 such as on a side of base 14 or within layer 12. The relative sizes, shapes and dimensions of chamber 16, channel 18, actuators 94 and 104, heater 92, upper portion 100 and optical window 134 are for illustrative purposes and can have other suitable sizes, shapes and dimensions in other embodiments. FIG. 13 is a cross-sectional view of one embodiment of a diagnostic test system. The diagnostic test system is shown generally at 144 and includes an optical window 146 and a sensor 148. In this embodiment, optical window 146 facilitates the detection of an analyte. Optical window 146 provides for the passage of electromagnetic radiation that can include visible light. Optical window 146 can be manufactured using any suitable material that is optically transparent. These materials include, but are not limited to, polypropylene and polycarbonate materials or glass. In the illustrated embodiment, optical window 146 is aligned to chamber 16 and can be used to monitor the progress of a reaction within chamber 16 or to monitor a reaction that provides a suitable result such as for detection of a desired analyte.

In the illustrated embodiment, sensor 148 is in proximity to optical window 146. In the illustrated embodiment, sensor 148 can be any suitable type of sensor that can detect the presence of or a change in electromagnetic radiation that results from a reaction that occurs within chamber 16. In the illustrated embodiment, sensor 148 converts the electromagnetic radiation to corresponding electrical signals. Sensor 146 is coupled to an electrical interface (not shown) and is adapted to transfer the electrical signals to the interface. In various embodiments, sensor 146 can be a photodiode, a charge-coupled device (CCD) or other suitable type of sensor. In various embodiments, sensor 146 can be used to measure properties of a fluid or reaction within chamber 16 that include, but are not limited to, luminescence, fluorescence, color, temperature, or electrical characteristics such as conductance. In other embodiments, sensor 148 can be located in any suitable area of base 14 or layer 12 or anywhere within chamber 16.

FIG. 14 is a cross-sectional view of one embodiment of a diagnostic test system. The diagnostic test system is shown generally at 150. Diagnostic test system 150 includes a valve 132 and a pump 152. Pump 152 includes a fluid chamber 154, a heater 156 and an elastomeric diaphragm 158. Heater 156 can be constructed using any suitable approach and includes the embodiments disclosed for heater 92 or heater 122. In one embodiment, heater 156 includes one or more resistive elements. In the illustrated embodiment, heater 156 is coupled to the electrical interface (not shown). When an electrical current is applied to heater 156 via the electrical interface, heat is transferred to a suitable actuation fluid contained within chamber 154. When the fluid in chamber 154 reaches a temperature that is sufficient to cause a vapor bubble to form, the vapor bubble builds up a localized pressure that expands diaphragm 158 in the direction of arrow 157. The pressure within chamber 16 created by the displacement or deformation of diaphragm 158 is sufficient to push a fluid in chamber 16 in the direction of arrow 159 towards valve 132. Valve 132 seals the fluid in chamber 16 when in the closed position as illustrated in FIG. 11, and allows a fluid to pass when in an open position as illustrated in FIG. 14. When the electrical current is removed from heater 156, chamber 154 cools sufficiently to allow the vapor bubble to collapse and the fluid in chamber 154 to revert back to a liquid state.

In various embodiments, chamber 154 can be coupled to and in fluid communication with one or more channels 18 or chambers 16. Chamber 154 can be coupled to an external port that is used to provide the actuation fluid to chamber 154. In various embodiments, the electrical current supplied to heater 156 can be varied to control the amount of displacement or deformation of diaphragm 158 thereby controlling the amount of pressure created within chamber 16. The relative sizes, shapes and dimensions of fluid chamber 154, heater 156, diaphragm 158, chamber 16, channel 18 or valve 132 are illustrative and can be other suitable sizes, shapes and dimensions in other embodiments. Although pump 152 is illustrated is being contained within base 14, in other embodiments, pump 152 can be built into layer 12, in other areas of base 14 such as on a side of base 14, or anywhere within chamber 16. Although one pump 152 is illustrated in chamber 16, in other embodiments, two or more pumps 152 can be contained within a chamber 16.

FIG. 15 is a cross-sectional view of one embodiment of a diagnostic test system. The diagnostic test system is shown generally at 160. Diagnostic test system 160 represents another embodiment of diagnostic test system 130 that includes two valves 132 illustrated as valve 132a and valve 132b. Diagnostic test system 160 also includes pump 88, heater 92 and optical window 134. Diagnostic test system 130 also includes an electrical interface (not shown) that is coupled to pump 88, heater 92 and valves 132a and 132b. Pump 88 is aligned with chamber 16 and can be activated to move a fluid out of chamber 16 in response to one or more signals that are provided via the electrical interface. Valve 132a and valve 132b seal a fluid in chamber 16 when in a closed position as illustrated in FIG. 15, and each or both can allow the fluid to pass when pump 88 is activated.

Valve 132a is located in channel 18a and includes upper portion 100a, actuator element 104a and lower portion 140a. Valve 132b is located in channel 18b and includes upper portion 10b, actuator element 104b and lower portion 140b. Actuator elements 104a and 104b are each coupled to the electrical interface. In various embodiments, suitable voltages having suitable polarities can be applied to actuator elements 104a and 104b at the same time or at different times to control the flow of a fluid into or out of chamber 16. Valves 132a and 132b can each operate between closed and fully open positions to maximize a fluid throughput, or can each operate between closed positions and any suitable number of open positions ranging from fully open to almost closed in order to regulate the amount of fluid that is allowed to pass. In other embodiments, there can be three or more channels 18 coupled to chamber 16, and any of the three or more channels 18 can include a valve 132.

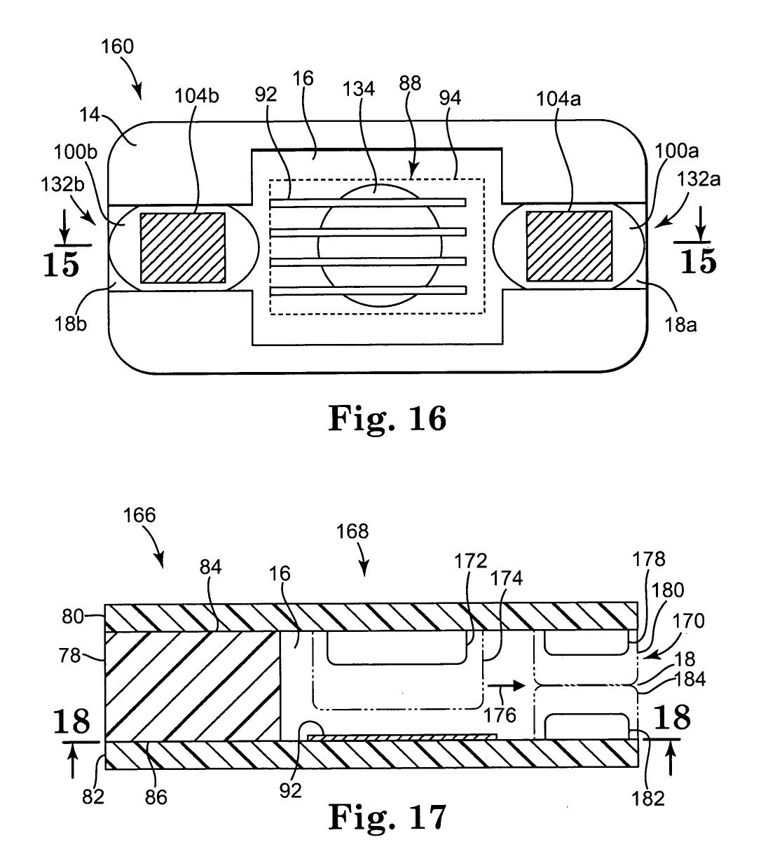

FIG. 16 is a top view of one embodiment of the diagnostic test system 160 that is illustrated in FIG. 15. The location of actuator element 94 is shown by a dashed line. In this embodiment, actuator element 94 and heater 92 are centered within or aligned to chamber 16. Actuator element 104a in upper portion 100a and actuator element 104b in upper portion 100b are aligned respectively to channels 18a and 18b. In other embodiments, actuator element 94 and heater 92 are not aligned to chamber 16. In other embodiments, actuator element 104a and actuator element 104b are not aligned respectively to channels 18a and 18b. Optical window 134 is centered within chamber 16 to enhance detection of a desired analyte. In other embodiments, optical window 134 is not centered within chamber 16 and is located in other suitable areas of chamber 16 such as on a side of base 14 or within layer 12. The relative sizes, shapes and dimensions of chamber 16, channel 18, actuator elements 94, 104a and 104b, heater 92, upper portions 100a and 100b, lower portions 140a and 140b, and optical window 134 are illustrative and can have other suitable sizes, shapes and dimensions in other embodiments.

FIG. 17 is a cross-sectional view of one embodiment of a diagnostic test system. The diagnostic test system is shown generally at 166. Diagnostic test system 166 includes a base 78, a first layer 80 and a second layer 82. Base 78, first layer 80 and second layer 82 can be formed from suitable materials in different embodiments that include the materials disclosed for diagnostic test system 76. In the illustrated embodiment, first layer 80 and second layer 82 are formed from elastomeric materials and base 78 is formed from a material that is more rigid than first layer 80 or second layer 82. In other embodiments, first layer 80 and/or second layer 82 can be formed from materials that are as rigid as base 78 or that are more rigid than base 78. In other embodiments, diagnostic test system 166 can include a layer 12 and a base 14.

In the embodiment illustrated in FIG. 17, base 78 includes one or more open areas that include portions of chamber 16 and channel 18. Layer 80 is attached to a first side of base 78 at a surface 84, and layer 82 is attached to a second side of base 78 at a surface 86. First layer 80 and second layer 82 cooperatively seal the open areas within base 78 to form chamber 16 and channel 18. While only one chamber 16 and one channel 18 are illustrated, in other embodiments, there can be any suitable number of chambers 16 and channels 18. In other embodiments, chamber 16 and channel 18 can have any suitable shape or size.

In the illustrated embodiment, diagnostic test system 166 includes a pump 168, a valve 170 and a heater 92. Diagnostic test system 166 also includes an electrical interface (not shown) that is coupled to pump 168, valve 170 and heater 92. In various embodiments, the electrical interface can be located on either side or within one or more of the base 78, the first layer 80 or the second layer 82. Pump 168 includes actuator element 172 that is aligned with and within an interior region of chamber 16. Pump 168 can be activated to move a fluid out of chamber 16 in response to one or more signals that are provided via the electrical interface to pump 168. Valve 170 includes upper actuator element 178 and lower actuator element 182. Upper actuator element 178 and lower actuator element 182 are within an interior region of channel 18. Valve 170 seals a fluid in chamber 16 when in a closed position and allows a fluid to pass when in an open position. In one embodiment, valve 170 controls the movement of a fluid through channel 18 by creating a deformation that changes a cross-sectional area of channel 18. In the illustrated embodiment, heater 92 is coupled to the electrical interface and is configured to raise a temperature of a fluid within chamber 16 in response to one or more signals that are provided to the electrical interface.

In the illustrated embodiment, actuator elements 172, 178 and 182 are made from any suitable electroactive polymer material that converts electrical energy into a mechanical motion when a voltage is applied. In these embodiments, the amount of movement or deformation of actuator elements 172, 178 and 182 can be controlled by application of suitable voltages having suitable polarities. In the embodiment illustrated in FIG. 17, actuator elements 172, 178 and 182 are formed from electroactive polymer or ionic polymer materials that undergo an electrochemical effect and volume change via the diffusion or mobility of ions when a suitable voltage is applied. The materials used for these electroactive polymers can include, but are not limited to, polymer-metal composites, conductive polymers, gels, and carbon nanotubes. In the illustrated embodiments, actuator elements 172, 178 and 182 can increase to any suitable volume and return to their original volume in response to the application of or change of suitable voltages having suitable polarities. In other embodiments, actuator elements 172, 178 and 182 can be made from other suitable electroactive polymer materials that include, but are not limited to, electrostrictive, electrostatic, piezoelectric, and ferroelectric polymer materials.

In the illustrated embodiment, actuator elements 172, 178 and 182 are illustrated in a non-activated state that corresponds to no voltages being applied. The dashed profiles illustrated at 174 for actuator element 172, illustrated at 180 for actuator element 178, and illustrated at 184 for actuator element 182, represent the increase in volume for actuator elements 172, 178 and 182 when in the activated state after the suitable voltages are applied. When the voltages are changed or removed, actuator elements 172, 178 and 182 return to their original shape or position. In various embodiments, actuator elements 172, 178 and 182 can have any suitable volume or shape when in the non-activated state or the activated state. While actuator 172 is illustrated as being attached to first layer 80, in other embodiments, actuator element 172 can be located on second layer 82, on base 78, or anywhere within chamber 16. Also, in other embodiments, there can be more than one actuator 172 within chamber 16.

In the illustrated embodiment, when pump 168 is activated after a suitable voltage is applied via the electrical interface, actuator element 172 increases in volume to the profile illustrated at 174 and creates a pressure within chamber 16 that is sufficient to push a fluid in chamber 16 in the direction of arrow 176 towards valve 170. When the voltage is changed or removed, actuator element 172 returns to its original shape or volume as illustrated by the profile at 172. The amount of volume increase of actuator element 172 and thus the amount of pressure created within chamber 16 can be controlled by applying suitable voltages to actuator element 172.

In the illustrated embodiment, actuator element 178 increases in volume to the profile illustrated at 180 when in the activated state after application of a suitable voltage via the electrical interface, and actuator element 182 increases in volume to the profile illustrated at 184 when in the activated state after application of a suitable voltage via the electrical interface. When in the activated state, actuator elements 178 and 182 are resiliently biased in a closed position thereby preventing a fluid from entering or leaving chamber 16. When the voltages applied to actuator elements 178 and 182 are changed or removed, actuator elements 178 and 182 reduce in volume to an open position that is sufficient to allow a fluid to pass through valve 170. In various embodiments, valve 170 can operate between closed and fully open positions to maximize a fluid throughput, or can operate between a closed position and any suitable number of open positions ranging from fully open to almost closed in order to regulate the amount of fluid that is allowed to pass. In other embodiments, actuator elements 178 and 182 can be located in other suitable locations such as on opposing sides of base 78 within chamber 16. In other embodiments, there is one actuator element (such as actuator element 178) that can operate between open and closed positions to control the flow of a fluid through channel 18. In other embodiments, there are more than two actuator elements.

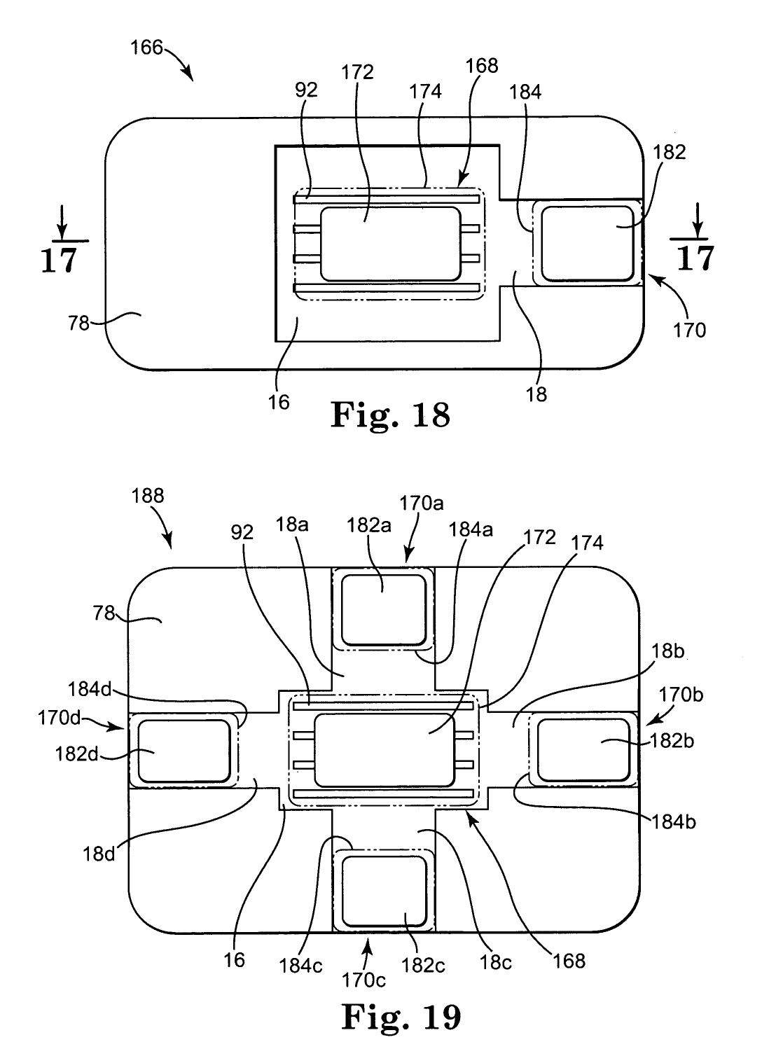

FIG. 18 is a top view of one embodiment of the diagnostic test system 166 illustrated in FIG. 17. In this embodiment, actuator element 172 and heater 92 are centered within or aligned to chamber 16. Actuator element 182 and actuator element 180 (not shown) are centered within or aligned to channel 18. In other embodiments, actuator element 172 or heater 92 are not aligned to chamber 16. In other embodiments, actuator element 178 or 182 are not aligned to channel 18. The relative sizes, shapes and dimensions of chamber 16, channel 18, actuator elements 172, 178 and 182 and heater 92 are illustrative and can have other suitable sizes, shapes and dimensions in other embodiments.

FIG. 19 is a top view of one embodiment of a diagnostic test system. The diagnostic test system is shown generally at 188. Diagnostic test system 188 includes pump 168 and valves 170 that are illustrated as valve 170a, 170b, 170c and 170d. The embodiments of pump 168 and valves 170 include those disclosed for diagnostic test system 166.

Valve 170a is located in channel 18a and includes an actuator element 182a that increases in volume to the profile at 184a when a suitable voltage is applied via the electrical interface (not shown). Valve 170b is located in channel 18b and includes an actuator element 182b that increases in volume to the profile at 184b when a suitable voltage is applied via the electrical interface (not shown). Valve 170c is located in channel 18c and includes an actuator element 182c that increases in volume to the profile at 184c when a suitable voltage is applied via the electrical interface (not shown). Valve 170d is located in channel 18d and includes an actuator element 182d that increases in volume to the profile at 184d when a suitable voltage is applied via the electrical interface (not shown).

In the illustrated embodiment, pump 168 includes actuator element 172. When a suitable voltage is applied via the electrical interface to actuator element 172, actuator element 172 increases in volume to the profile illustrated at 174 and creates a pressure within chamber 16 that is sufficient to push a fluid in chamber 16 in the direction of valves 170a, 170b, 170c and 170d. Opening any one or more of the valves 170a, 170b, 170c or 170d will allow the fluid to pass to the respective channels 18a, 18b, 18c or 18d. Each one of valves 170a, 170b, 170c and 170d can control the flow of a fluid into or out of chamber 16. When another pump 168 (not shown) is activated and is pushing a fluid towards any of the channels 18a, 18b, 18c or 18d, opening the corresponding valve 170a, 170b, 170c or 170d will allow the fluid to pass into chamber 16. In various embodiments, valves 170 can be located in chamber 16, channels 18 or in both chamber 16 and channels 18. The relative sizes, shapes and dimensions shown for chamber 16, channels 18, pump 168, valves 170 and heater 92 are illustrative and can be other suitable sizes, shapes and dimensions in other embodiments.

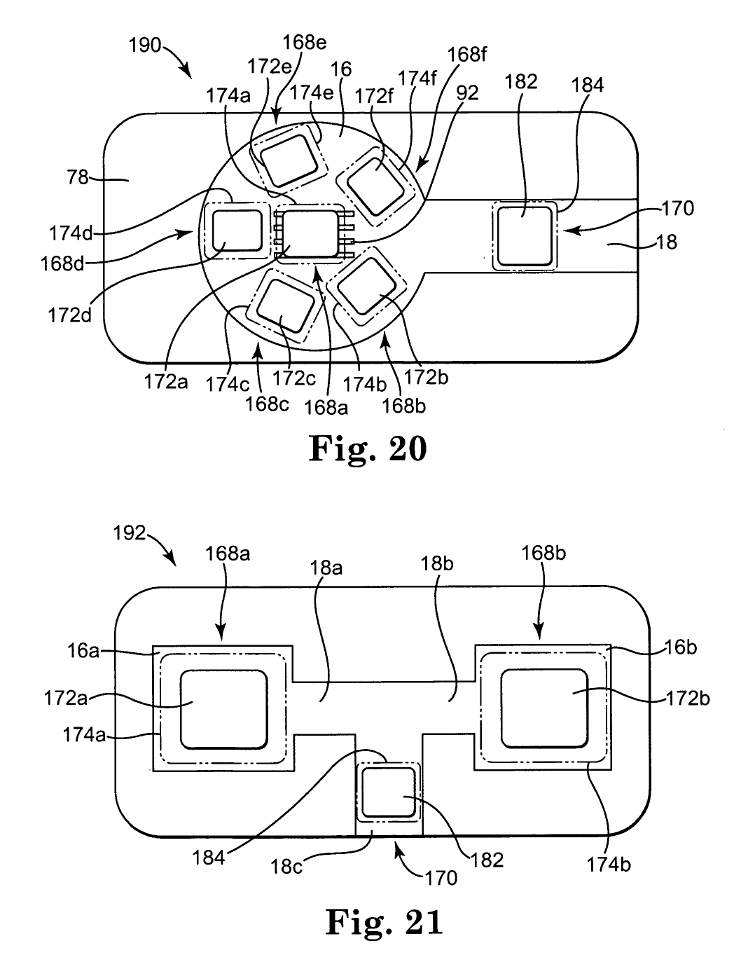

FIG. 20 is a top view of one embodiment of a diagnostic test system. The diagnostic test system is shown generally at 190. Diagnostic test system 190 includes a valve 170 and six pumps 168 illustrated at 168a, 168b, 168c, 168d, 168e and 168f. The embodiments of pumps 168 and valve 170 include those disclosed for diagnostic test system 166 or diagnostic test system 188. Valve 170 is located in channel 18 and includes an actuator element 182. Actuator element 182 increases in volume to the profile at 184 when a suitable voltage is applied via the electrical interface (not shown). Pumps 168a, 168b, 168c, 168d, 168e and 168f include, respectively, actuator elements 172a, 172b, 172c, 172d, 172e and 178f. When suitable voltages are applied via the electrical interface to one or more of the actuator elements 172a, 172b, 172c, 172d, 172e or 172f, the actuator elements 172a, 172b, 172c, 172d, 172e or 172f that are receiving the voltage increase in volume, respectively, to the profiles illustrated at 174a, 174b, 174c, 174d, 174e or 174f.

In some embodiments, the voltages being applied to one or more of the actuator elements 172 creates a pressure within chamber 16 that is sufficient to push a fluid in chamber 16 towards valve 170. In one embodiment, voltages are applied to all of the actuator elements 172 at the same time to push the fluid in chamber 16 towards valve 170.

In some embodiments, the voltages are applied to the actuator elements 172 at different times to push the fluid towards valve 170. For example, the voltages could be applied first to actuator element 172d, next to actuator elements 172c and 172e, next to actuator element 172a, and next to actuator elements 172b and 172f. The sequential activation of actuator elements 172 pushes the fluid towards valve 170.

In some embodiments, the voltages are applied to the actuator elements 172 in a suitable sequence to achieve a mixing or shaking of a fluid within chamber 16. In these embodiments, the actuator elements 172 are activated and deactivated in accordance with the sequence. In one embodiment, the actuator elements are activated and deactivated in a sequential order that is 172a, 172f, 172d, 172b, 172e and 172c. This sequence can be repeated any suitable number of times. In other embodiments, other suitable sequences or a random sequence can be used.

In some embodiments, the voltages are applied to the actuator elements 172 in a sequence to vortex a fluid within chamber 16. In these embodiments, the actuator elements 172 can be activated and deactivated in a suitable sequence to move the fluid in a clockwise or a counter-clockwise direction. In one embodiment, actuator element 172a is activated and other actuator elements 172 are activated and deactivated in a sequential order that is 172b, 172c, 172d, 172e and 172f. This sequence can be repeated any suitable number of times. In one embodiment, actuator element 172a is activated and actuator elements are activated and deactivated in a sequential order that is 172f, 172e, 172d, 172c and 172b. This sequence can be repeated any suitable number of times. In other embodiments, actuator element 172a is not present and only five actuator elements 172 are activated or deactivated in a sequential order that is 172b, 172c, 172d, 172e and 172f. This sequence can be repeated any suitable number of times. In other embodiments, there can be any suitable number of actuator elements 172, and the actuator elements 172 can be activated and deactivated in any suitable sequence.

FIG. 21 is a top view of one embodiment of a diagnostic test system. The diagnostic test system is shown generally at 192. Diagnostic test system 192 includes a valve 170 and two pumps 168 illustrated at 168a and 168b. The embodiments of pumps 168 and valve 170 include those disclosed for diagnostic test systems 166, 188, 190 and 192. Valve 170 is located in channel 18c and includes an actuator element 182 that increases in volume to the profile at 184 when a suitable voltage is applied via the electrical interface (not shown). Pumps 168a and 168b, include, respectively, actuator elements 172a and 172b. When suitable voltages are applied via the electrical interface to actuator elements 172a or 172b, actuator elements 172a or 172b increase in volume, respectively, to the profiles illustrated at 174a or 174b.

In one embodiment, the voltages are applied sequentially to actuator elements 172a and 172b to achieving a mixing of a fluid. Initially, valve 170 is closed. If pump 168b is deactivated and pump 168a is activated, actuator element 172a expands to the profile at 174a and creates a pressure within chamber 16a that is sufficient to push a fluid in chamber 16a to chamber 16b via channels 18a and 18b. Alternatively, if pump 168a is deactivated and pump 168b is activated, actuator element 172b expands to the profile at 174b and creates a pressure within chamber 16b that is sufficient to push the fluid in chamber 16b to chamber 16a via channels 18b and 18a. In one embodiment, the sequence of deactivating pump 168b and activating pump 168a is completed once. In one embodiment, the sequence of deactivating pump 168a and activating pump 168b is completed once. In other embodiments, the sequence of deactivating pump 168b and activating pump 168a, and then deactivating pump 168a and activating pump 168b, is completed one or more times to complete a suitable mixing of the fluid.

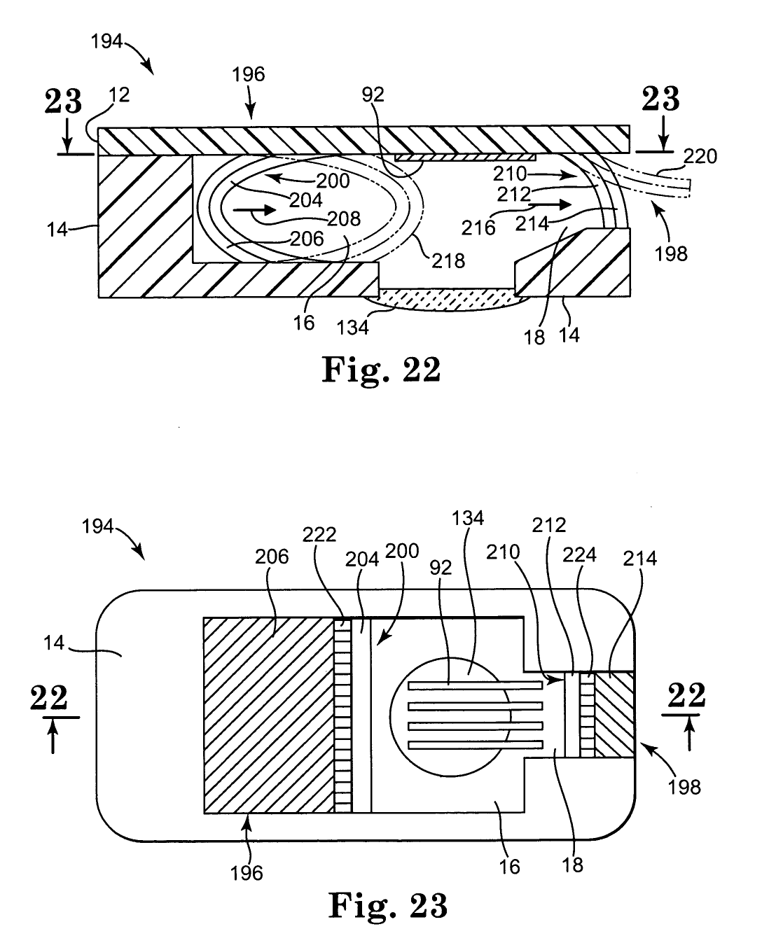

FIG. 22 is a cross-sectional view of one embodiment of a diagnostic test system. The diagnostic test system is shown generally at 194. Diagnostic test system 194 represents another embodiment of diagnostic test system 10 and includes a layer 12 and a base 14. Layer 12 and base 14 are attached to form a chamber 16 and a channel 18. The materials and embodiments of layer 12 and base 14 include those disclosed in FIGS. 1-4. In various embodiments, base 14 can be formed from materials that can be more flexible, have the same flexibility, or have a lesser flexibility than layer 12. In the illustrated embodiment, base 14 is formed from a substantially rigid material and layer 12 is formed from a flexible material. In other embodiments, diagnostic test system 194 can be formed from a base 78, a first layer 80 and a second layer 82.

In the illustrated embodiment, diagnostic test system 194 includes a pump 196, a heater 92, a valve 198 and an optical window 134. Diagnostic test system 194 also includes an electrical interface (not shown) that is coupled to pump 196, heater 92 and valve 198. Pump 196 can be activated to move a fluid in the direction of arrow 208 in response to one or more signals that are provided via the electrical interface. Valve 198 seals a fluid in chamber 16 when in a closed position and allows the fluid to pass when in an open position. In one embodiment, valve 198 controls the movement of a fluid through channel 18 by creating a deformation that changes a cross-sectional area of channel 18. In the illustrated embodiment, heater 92 is coupled to the electrical interface and is configured to raise a temperature of a fluid within chamber 16 in response to one or more signals that are provided to heater 92 via the electrical interface.

In the illustrated embodiment, pump 196 includes actuator element 200 and valve 198 includes actuator element 210. Actuator element 200 is within an interior region of chamber 16 and actuator 210 is within an interior region of channel 18. Actuator elements 200 and 210 have a bilayer construction and are formed by attaching a layer which is an electroactive polymer to a layer that is any suitable material that does not change in volume when a voltage is applied. The displacement or deformation of the electroactive polymer when a suitable voltage is applied causes actuator elements 200 and 210 to flex or bend. In various embodiments, the electroactive polymer can be an ionic polymer, an electronic polymer or other suitable type of electroactive polymer.

In one embodiment, actuator element 200 and actuator element 210 are formed from ionic polymer materials. Application of a suitable voltage causes the ionic polymer materials to expand in volume due to an electrochemical effect that results from the diffusion or mobility of ions. This expansion causes actuator elements 200 and 210 to bend. Through an application of suitable voltages having suitable polarities, the amount of bending or deformation of actuator elements 200 and 210 can be controlled. The amount of flexing or bending illustrated at profiles 218 and 220 is exemplary, and in other embodiments, the amount of flexing or bending can be any suitable amount. Once the voltages provided to actuator elements 200 and 210 are changed or removed, actuator elements 200 and 210 return to their original positions as illustrated at 200 and 210. In various embodiments, the ionic polymer materials can include, but are not limited to, polymer-metal composites, conductive polymers, gels, and carbon nanotubes.

In one embodiment, actuator element 200 and actuator element 210 are formed from electronic polymer materials that undergo displacement or deformation in the presence of an electric field. In this embodiment, the electroactive polymers can include, but are not limited to, electrostrictive, electrostatic, piezoelectric, and ferroelectric polymers. In some embodiments, actuator elements 200 and 210 include a polymer elastomer dielectric material that is coated on both sides with elastomer conductive films. Application of a voltage between the two films creates an electrostatic force that compresses the polymer material. The volume of the polymer material does not change so that compression of the polymer material in one direction causes the polymer material to expand in one or more other directions in order to maintain the volume at a constant. This expansion creates the displacement or deformation. This expansion causes actuator elements 200 and 210 to flex or bend. Through application of suitable voltages having suitable polarities, the amount of flexing or bending of actuator elements 200 and 210 can be controlled. The amount of flexing or bending illustrated at profiles 218 and 220 is exemplary, and in other embodiments, the amount of flexing or bending can be any suitable amount. Once the voltages are changed or removed, actuator elements 200 and 210 return to their original positions as illustrated at 200 and 210.

In the illustrated embodiment, actuator element 200 includes a layer 204 that is an electroactive polymer and a layer 206 that is a suitable material that does not change in volume when a voltage is applied. When a voltage is applied to actuator element 200, layer 204 expands and causes actuator element 200 to flex or bend to the profile illustrated at 218. This flexing or bending creates a pressure within chamber 16 that pushes a fluid within chamber 16 in the direction of arrow 208. In this embodiment, layer 12 and base 14 are designed to accommodate the bending of actuator 200. In one embodiment, layer 12 is formed from a suitable elastomeric material and flexes upward to accommodate the bending of actuator 200. In other embodiments, actuator element 200 can be attached to any suitable location within chamber 16. In other embodiments, actuator element 200 can be attached at one end to layer 12 or base 14. In other embodiments, layer 12 or base 14 have openings or recessed areas that accommodate the movement of actuator 200. In other embodiments, there can be more than one actuator element 200. In the illustrated embodiment, when the voltage is changed or removed, actuator element 200 returns to its original position as illustrated at 200. In various embodiments, pump 196 can operate between any suitable number of positions over any suitable period of time to optimize a pressure created within chamber 16.

In the illustrated embodiment, actuator element 210 includes a layer 212 that is an electroactive polymer and a layer 214 that is a suitable material that does not change in volume when a voltage is applied. When a voltage is applied to actuator element 210, layer 212 expands and causes actuator element 210 to bend to the profile illustrated at 220. This bending provides an opening through valve 198 that permits a fluid in chamber 16 to pass through valve 198 in the direction of arrow 216. In the illustrated embodiment, when the voltage is changed or removed, actuator element 210 returns to its original position as illustrated at 210. In various embodiments, valve 198 can operate between any suitable number of positions over any suitable period of time to optimize a fluid throughput through channel 18. Valve 198 can also operate between closed and fully open positions to maximize a fluid throughput, or can operate between a closed position and any suitable numbers of open positions ranging from fully open to almost closed in order to regulate the amount of fluid that is allowed to pass through channel 18 when valve 198 is activated. In other embodiments, there can be more than one actuator element 210. In other embodiments, actuator element 210 can be attached to any suitable location within channel 18 such as to base 14. In other embodiments, actuator element 210 can operate as a pump. In these embodiments, actuator element 210 can be located within chamber 16 and be activated to move a fluid within chamber 16, or can be located within channel 18 and be activated to move a fluid within channel 18.

In the illustrated embodiment, optical window 134 facilitates the detection of an analyte by providing for the passage of electromagnetic radiation that can include visible light. Embodiments of optical window 134 include the embodiments disclosed for diagnostic test systems 130, 144 and 160.

FIG. 23 is a top view of the diagnostic test system 194 that is illustrated in FIG. 22. In this embodiment, heater 92 is centered within or aligned to chamber 16. In other embodiments, heater 92 is not aligned to chamber 16 and can be attached at any suitable location within chamber 16. Actuator 200 is attached at end 222 to layer 12. In various embodiments, actuator 200 can be attached to either layer 12 or base 14 at any suitable location within chamber 16. Actuator 210 is attached at end 224 to layer 12. In other embodiments, actuator 210 can be attached to either layer 12 or base 14 at any suitable location within channel 18. Optical window 134 is centered or aligned to chamber 16 to enhance detection of a desired analyte. In other embodiments, optical window 134 is not centered to chamber 16 and is located within any suitable area of chamber 16 such as on a side of base 14 or within layer 12. The relative sizes, shapes and dimensions of chamber 16, channel 18, actuator elements 200 and 210, heater 92 and optical window 134 are illustrative and can be other suitable sizes, shapes and dimensions in other embodiments.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A diagnostic test system, comprising:
a first layer;
a base, wherein the first layer is attached to the base to form one or more chambers; and
one or more pumps, wherein each one of the one or more pumps is configured to control a movement of a fluid within one of the one or more chambers by creating a deformation that changes a volume of the one of the one or more chambers.

2. The diagnostic test system of claim 1, wherein each one of the one or more pumps comprises an actuator element that is attached to the first layer, wherein the actuator element is configured to flex in response to one or more electrical signals and create the deformation in the first layer to change the volume of the one of the one or more chambers.

3. The diagnostic test system of claim 2, wherein the actuator element comprises a piezoelectric material.

4. The diagnostic test system of claim 2, wherein the actuator element comprises an electroactive polymer material.

5. The diagnostic test system of claim 1, wherein each one of the one or more pumps comprises an actuator element that is attached to an interior region of the one of the one or more chambers, wherein the actuator element undergoes the deformation in response to one or more electrical signals and changes the volume of the one of the one or more chambers.

6. The diagnostic test system of claim 5, wherein the actuator element comprises an electroactive polymer that undergoes the deformation by changing in volume in response to the one or more signals.

7. The diagnostic test system of claim 5, wherein the actuator element comprises an electroactive polymer layer that is attached to a layer that has a constant volume, wherein a displacement of the electroactive polymer layer in response to the one or more signals causes the actuator element to undergo the deformation by flexing in a direction that changes the volume of the one of the one or more chambers.

8. The diagnostic test system of claim 1, wherein each one of the one or more pumps comprises:
a fluid chamber that includes an actuation fluid;
a heater contained within the fluid chamber; and
a diaphragm that separates the fluid chamber from the one of the one or more chambers, wherein the diaphragm is configured to undergo the deformation by expanding to change the volume of the one of the one or more chambers in response to a heat-induced localized pressure within the fluid chamber.

9. The diagnostic test system of claim 1, comprising:
one or more channels coupled to the one or more chambers; and
one or more valves, wherein each one of the one or more valves is configured to control the movement of the fluid through one of the one or more channels by creating a deformation that changes a cross-sectional area of the one of the one or more channels.

10. The diagnostic test system of claim 9, wherein each one of the one or more valves comprises an actuator element that includes a piezoelectric material that is within an interior region of the one of the one or more channels, wherein the actuator element undergoes the deformation in response to one or more electrical signals to control the flow of a fluid through the one of the one or more chambers.

11. The diagnostic test system of claim 9, wherein each one of the one or more valves comprises an actuator element that includes an electroactive polymer material that is within an interior region of the one of the one or more channels, wherein the actuator element undergoes the deformation in response to one or more electrical signals to control the flow of a fluid through the one of the one or more chambers.

12. The diagnostic test system of claim 1, comprising a second layer that is attached to the base, wherein the first layer and the second layer are attached to opposing sides of the base to form the one or more chambers and one or more channels.

13. A diagnostic test system, comprising:
a substantially rigid base;
a first flexible layer;
a second flexible layer, wherein the first layer and the second layer are attached to opposing sides of the base to form one or more chambers and one or more channels;
an electrical interface;
one or more pumps coupled to the electrical interface, wherein each one of the one or more pumps is configured to control a movement of a fluid within one of the one or more chambers by creating a deformation that changes a volume of the one of the one or more chambers; and
one or more valves coupled to the electrical interface, wherein each one of the one or more valves is configured to control the movement of the fluid through one of the one or more channels by creating the deformation that changes a cross-sectional area of the one of the one or more channels.

14. The diagnostic test system of claim 13, wherein each one of the one or more pumps or each one of the one or more valves comprises a piezoelectric material that is configured to create the deformation by flexing in response to the one or more electrical signals.

15. The diagnostic test system of claim 13, wherein each one of the one or more pumps or each one of the one or more valves comprises an electroactive polymer material that is configured to create the deformation response to the one or more electrical signals.

16. The diagnostic test system of claim 13, wherein the base comprises a material selected from a group consisting of metal, polyester, polypropylene, polyethylene, polystyrene or polyurethane, polyvinyl chloride, polyvinylidene chloride and polycarbonate.

17. The diagnostic test system of claim 13, wherein at least one of the one or more chambers comprises a heater configured to increase a temperature within the at least one of the one or more chambers.

18. The diagnostic test system of claim 13, wherein at least one of the one or more chambers is configured to be preloaded with a reagent that is selected from the group consisting of a fluorescent marker, a chemiluminescent marker, a calorimetric marker, an enzymatic marker and a radioactive marker.

19. The diagnostic test system of claim 13, comprising at least one optical window that is aligned with a corresponding at least one of the one or more chambers, wherein the at least one optical window is configured to pass electromagnetic radiation that results from a reaction that occurs within the at least one of the one or more chambers.

20. A method of conducting a diagnostic test, comprising:
providing a diagnostic test system that includes one or more chambers and one or more pumps; and
applying an electrical signal to at least one of the one or more pumps to control a movement of a fluid within one of the one or more chambers by creating a deformation that changes a volume of the one of the one or more chambers.

21. The method of claim 20, wherein creating the deformation comprises applying the electrical signal to an actuator element that includes a piezoelectric material to flex the actuator element and the first layer to change the volume of the one of the one or more chambers.

22. The method of claim 20, wherein creating the deformation comprises applying the electrical signal to an actuator element that includes an electroactive polymer material to flex the actuator element and the first layer to change the volume of the one of the one or more chambers.

23. The method of claim 20, wherein creating the deformation comprises applying the electrical signal to an actuator element that includes an electroactive polymer material that is within an interior region of the one of the one or more chambers to change the volume of the actuator element to change the volume of the one of the one or more chambers.

24. The method of claim 20, wherein creating the deformation comprises applying the electrical signal to an actuator element that includes an electroactive polymer material that is within an interior region of the one of the one or more chambers to flex the actuator element to change the volume of the one of the one or more chambers.
